(19) United States
(12) Patent Application Publication
(10) Pub. No.: US 2026/0124686 A1
(43) Pub. Date: May 7, 2026

(54) EXTENDED LENGTH HARDWARE JIG

(71) Applicant: Kreg Enterprises, Inc., Ankeny, IA (US)

(72) Inventors: Veldin Cosic, Ankeny, IA (US); Nathan Hagarty, Des Moines, IA (US); Kyong S. Choi, Ames, IA (US); Stacy Peterson, Ames, IA (US); Jens Pedersen, Des Moines, IA (US); Chris Baker, Polk City, IA (US); Garrett Sherman, Des Moines, IA (US)

(21) Appl. No.: 19/377,685

(22) Filed: Nov. 3, 2025

Related U.S. Application Data
(60) Provisional application No. 63/717,340, filed on Nov. 7, 2024.

(51) Int. Cl. B23B 47/28

(52) U.S. Cl. CPC B23B 47/287

(57) ABSTRACT

In one or more exemplary arrangements, a jig system for locating holes on a workpiece is presented. In one or more arrangements, the jig includes a rail, first and second extension members, a first outer block assembly operatively connected to the first extension member and the rail, and a second outer block assembly operatively connected to the second extension member and the rail. In one or more arrangements, the first outer block assembly and the second outer block assembly are movable along the rail in a first direction. In one or more arrangements, the first and second outer block assemblies are movable along the first and second extension members in a second direction. In one or more arrangements, a drill is configured to extend through a first and second drill aperture of the first and second outer block assemblies to drill holes in the workpiece.

### CROSS-REFERENCE TO RELATED APPLICATIONS

This application claims priority to U.S. Provisional Application 63/717,340, titled “EXTENDED LENGTH HARDWARE JIG”, and filed Nov. 7, 2024, the entirety of which is hereby incorporated by reference herein, including any figures, tables, drawings, or other information.

### FIELD OF THE DISCLOSURE:

This disclosure relates to a hardware jig. More specifically, this disclosure relates to a hardware jig for accurately locating holes for large pulls on workpieces such as cabinet doors and drawer faces.

### OVERVIEW OF THE DISCLOSURE

Doors and drawers typically include handles which can be grasped by users of the door or drawer. These doors and drawers may have a significant length and/or height and the handles attached to these doors may also have a significant length and/or height. In most cases, long handles include holes at each end where screws must be placed through the door or drawer and into the holes of the handles in order to connect the handles to the door or drawer. Holes must be made in the door or drawer in order for the screws to extend through the door or drawer and these holes must be placed accurately in order to properly and securely connect the handle to the door or drawer.

In order to position these holes in the door or drawer correctly, the person drilling the holes must accurately measure the position of the holes relative to one another. There are jigs in the industry that have been used to assist persons in positioning the holes in the door or drawer correctly, however these jigs are often subject to multiple different tolerances that cumulatively affect the precision in the placement of the holes in the doors or drawers. Especially when dealing with long handles, cumulative tolerances can result in holes that are positioned significantly away from where they need to be.

Therefore, for all the reasons stated above, and the reasons stated below, there is a need in the art for an improved hardware jig which can accurately locate holes for large pulls on workpieces such as cabinet doors and drawer faces. Thus, it is a primary objective of the disclosure to provide an extended length hardware jig that improves upon the state of the art.

Another objective of the disclosure is to provide an extended length hardware jig which is safe to operate.

Another objective of the disclosure is to provide an extended length hardware jig which is able to expand in order to properly place holes in workpieces such as doors or drawers.

Yet another objective of the disclosure is to provide an extended length hardware jig which is relatively easy to build.

Another objective of the disclosure is to provide an extended length hardware jig which is relatively friendly to build.

Yet another objective of the disclosure is to provide an extended length hardware jig which can be built relatively quickly and efficiently.

Another objective of the disclosure is to provide an extended length hardware jig which is easy to operate.

Yet another objective of the disclosure is to provide an extended length hardware jig which is relatively cost friendly to manufacture.

Another objective of the disclosure is to provide an extended length hardware jig which is relatively easy to transport.

Yet another objective of the disclosure is to provide an extended length hardware jig which is aesthetically appealing.

Another objective of the disclosure is to provide an extended length hardware jig which is robust.

Another objective of the disclosure is to provide an extended length hardware jig which is relatively inexpensive.

Yet another objective of the disclosure is to provide an extended length hardware jig which is not easily susceptible to wear and tear.

Another objective of the disclosure is to provide an extended length hardware jig which has a long useful life.

Yet another objective of the disclosure is to provide an extended length hardware jig which is efficient to use and operate.

Another objective of the disclosure is to provide an extended length hardware jig which is accurate over long distances.

These and other objects, features, or advantages of the disclosure will become apparent from the specification, figures, and claims.

### SUMMARY OF THE DISCLOSURE:

In one or more exemplary arrangements, a jig system for locating holes on a workpiece is presented. In one or more arrangements, the jig includes a rail extending a length between a first end and a second end, a first extension member extending a length between a first end and a second end, a second extension member extending a length from a first end and a second end, a first outer block assembly operatively connected to the first extension member and the rail, and a second outer block assembly operatively connected to the second extension member and the rail. In one or more arrangements, the first outer block assembly and the second outer block assembly are movable along the rail in a first direction. In one or more arrangements, the first and second outer block assemblies are movable along the first and second extension members in a second direction. In one or more arrangements, a drill is configured to extend through a first and second drill aperture of the first and second outer block assemblies to drill holes in the workpiece.

### BRIEF DESCRIPTION OF THE FIGURES:

FIG. 1 shows a front view of an extended length hardware jig, in accordance with one or more arrangements; the view showing the jig having a rail with indicia and including outer block assemblies, a center block, and an end stop attached thereto.

FIG. 2 shows a front perspective view of an extended length hardware jig, in accordance with one or more arrangements; the view showing the jig having a rail with outer block assemblies, a center block, and an end stop attached thereto.

FIG. 3 shows a front elevation view of an extended length hardware jig, in accordance with one or more arrangements; the view showing the jig having a rail with outer block assemblies, a center block, and an end stop attached thereto.

FIG. 4 shows a back elevation view of an extended length hardware jig, in accordance with one or more arrangements; the view showing the jig having a rail with outer block assemblies, a center block, and an end stop attached thereto.

FIG. 5 shows a top elevation view of an extended length hardware jig, in accordance with one or more arrangements; the view showing the jig having a rail with outer block assemblies, a center block, and an end stop attached thereto.

FIG. 6 shows a front perspective view of an extended length hardware jig, in accordance with one or more arrangements; the view showing the jig having a rail with outer block assemblies, a center block, and an end stop attached thereto.

FIG. 7 shows a rear perspective view of an extended length hardware jig, in accordance with one or more arrangements; the view showing the jig having a rail with outer block assemblies, a center block, and an end stop attached thereto.

FIG. 8 shows a front bottom perspective view of an extended length hardware jig, in accordance with one or more arrangements; the view showing the jig having a rail with outer block assemblies, a center block, and an end stop attached thereto.

FIG. 9 shows a rear bottom perspective view of an extended length hardware jig, in accordance with one or more arrangements; the view showing the jig having a rail with outer block assemblies, a center block, and an end stop attached thereto.

FIG. 10 shows a front perspective exploded view of an extended length hardware jig, in accordance with one or more arrangements; the view showing the jig having a rail with outer block assemblies, a center block, rail connectors, and an end stop.

FIG. 11 shows a rear perspective exploded view of an extended length hardware jig, in accordance with one or more arrangements; the view showing the jig having a rail with outer block assemblies, a center block, rail connectors, and an end stop.

FIG. 12 shows a front perspective exploded view of an extended length hardware jig, in accordance with one or more arrangements; the view showing the jig having a rail with outer block assemblies, a center block, rail connectors, and an end stop.

FIG. 13 shows a front elevation view of a rail of an extended length hardware jig, in accordance with one or more arrangements; the view showing the rail having a planar front surface.

FIG. 14 shows a rear elevation view of a rail of an extended length hardware jig, in accordance with one or more arrangements; the view showing the rail having a channel on the back side of the rail.

FIG. 15 shows a side elevation view of a rail of an extended length hardware jig, in accordance with one or more arrangements; the view showing the rail having a channel formed by an upper and lower protrusion on the back side of the rail.

FIG. 16 shows a front elevation view of a rail of an extended length hardware jig, in accordance with one or more arrangements; the view showing the rail having a planar front surface.

FIG. 17 shows a front perspective view of a rail of an extended length hardware jig, in accordance with one or more arrangements; the view showing the rail having a planar front surface.

FIG. 18 shows a rear perspective view of a rail of an extended length hardware jig, in accordance with one or more arrangements; the view showing the rail having a channel formed by an upper and lower protrusion on the back side of the rail.

FIG. 19 shows a front elevation view of a rail connector of an extended length hardware jig, in accordance with one or more arrangements; the view showing the rail connector having a plurality of holes configured to receive a plurality of fasteners.

FIG. 20 shows a front exploded view of a rail connector of an extended length hardware jig, in accordance with one or more arrangements; the view showing the rail connector having a plurality of holes configured to receive a plurality of fasteners.

FIG. 21 shows a rear elevation view of a rail connector of an extended length hardware jig, in accordance with one or more arrangements; the view showing the rail connector having a plurality of holes configured to receive a plurality of fasteners.

FIG. 22 shows a front perspective view of a rail connector of an extended length hardware jig, in accordance with one or more arrangements; the view showing the rail connector having a plurality of holes.

FIG. 23 shows a front perspective view of an outer block assembly of an extended length hardware jig, in accordance with one or more arrangements; the view showing the outer block assembly having a body configured to receive a rail and an extension member attached thereto.

FIG. 24 shows a side perspective view of an outer block assembly of an extended length hardware jig, in accordance with one or more arrangements; the view showing the outer block assembly having a body configured to receive a rail and an extension member attached thereto.

FIG. 25 shows a side perspective view of an outer block assembly of an extended length hardware jig, in accordance with one or more arrangements; the view showing the outer block assembly having a body configured to receive a rail and an extension member attached thereto.

FIG. 26 shows a top elevation view of an outer block assembly of an extended length hardware jig, in accordance with one or more arrangements; the view showing the outer block assembly having a body and an extension member attached thereto.

FIG. 27 shows a rear elevation view of an outer block assembly of an extended length hardware jig, in accordance with one or more arrangements; the view showing the outer block assembly having a body and an extension member attached thereto.

FIG. 28 shows a front elevation view of an outer block assembly of an extended length hardware jig, in accordance with one or more arrangements; the view showing the outer block assembly having a body and an extension member attached thereto.

FIG. 29 shows a side elevation view of an outer block assembly of an extended length hardware jig, in accordance with one or more arrangements; the view showing the outer block assembly having a body attached to a rail and an extension member attached thereto.

FIG. 30 shows a rear perspective view of an outer block assembly of an extended length hardware jig, in accordance with one or more arrangements; the view showing the outer block assembly having a body configured to receive a rail and an extension member attached thereto.

FIG. 31 shows an exploded view of a main body of an outer block assembly of an extended length hardware jig, in accordance with one or more arrangements; the view showing the main body having an opening to receive a rail, a fastener, and a drill aperture.

FIG. 32 shows a front elevation view of a main body of an outer block assembly of an extended length hardware jig, in accordance with one or more arrangements; the view showing the main body having a window, a fastener, and a drill aperture.

FIG. 33 shows an exploded view of an outer block assembly of an extended length hardware jig, in accordance with one or more arrangements; the view showing the outer block assembly having an extension member, a main body, an end plate, and fasteners.

FIG. 34 shows a front elevation view of a pair of outer block assemblies and a center block of an extended length hardware jig, in accordance with one or more arrangements; the view showing the center block having a window, a drill aperture, and a fastener attached thereto.

FIG. 35 shows a front perspective view of a center block of an extended length hardware jig, in accordance with one or more arrangements; the view showing the center block having a window, a drill aperture, and an opening configured to receive a rail.

FIG. 36 shows a front perspective view of an end stop of an extended length hardware jig, in accordance with one or more arrangements; the view showing the end stop having an opening configured to receive a rail and a fastener.

FIG. 37 shows a side elevation view of an end stop of an extended length hardware jig, in accordance with one or more arrangements; the view showing the end stop having an opening configured to receive a rail and a fastener.

FIG. 38 shows a rear perspective view of an end stop of an extended length hardware jig, in accordance with one or more arrangements; the view showing the end stop having an opening configured to receive a rail and a fastener.

FIG. 39 shows a front view of an extended length hardware jig engaging with a workpiece, in accordance with one or more arrangements; the view showing a pair of outer assemblies and an end stop engaging edges of the workpiece.

FIG. 40 shows a front view of an extended length hardware jig engaging with a workpiece, in accordance with one or more arrangements; the view showing a pair of outer assemblies and an end stop engaging edges of the workpiece.

FIG. 41 shows a side perspective view of an extended length hardware jig engaging with a workpiece, in accordance with one or more arrangements; the view showing a pair of outer assemblies and an end stop engaging edges of the workpiece.

FIG. 42 shows a side perspective view of an extended length hardware jig engaging with a workpiece, in accordance with one or more arrangements; the view showing a pair of outer assemblies and an end stop engaging edges of the workpiece.

FIG. 43 shows a front view of an extended length hardware jig engaging with a workpiece, in accordance with one or more arrangements; the view showing a pair of outer assemblies engaging edges of the workpiece.

FIG. 44 shows a front perspective view of an extended length hardware jig engaging with a workpiece, in accordance with one or more arrangements; the view showing a pair of outer assemblies engaging edges of the workpiece.

FIG. 45 shows a front view of an outer block assembly of an extended length hardware jig engaging with a workpiece, in accordance with one or more arrangements; the view showing a drill aperture set to a predetermined position using indicia on a rail and indicia on an extension member of the outer block assembly.

FIG. 46 shows a top perspective view of an end stop of an extended length hardware jig engaging with a workpiece, in accordance with one or more arrangements; the view showing the end stop set to a predetermined position using indicia on a rail that extends through an opening of the end stop.

FIG. 47 shows a front view of an extended length hardware jig engaging with a workpiece, in accordance with one or more arrangements; the view showing a pair of outer assemblies and an end stop engaging edges of the workpiece.

FIG. 48 shows a front perspective view of an extended length hardware jig, in accordance with one or more arrangements; the view showing the jig having a rail with outer block assemblies, a center block, and an end stop attached thereto.

FIG. 49 shows a front elevation view of an extended length hardware jig, in accordance with one or more arrangements; the view showing the jig having a rail with outer block assemblies, a center block, and an end stop attached thereto.

FIG. 50 shows a rear elevation view of an extended length hardware jig, in accordance with one or more arrangements; the view showing the jig having a rail with outer block assemblies, a center block, and an end stop attached thereto.

FIG. 51 shows a bottom elevation view of an extended length hardware jig, in accordance with one or more arrangements; the view showing the jig having a rail with outer block assemblies, a center block, and an end stop attached thereto.

FIG. 52 shows a top elevation view of an extended length hardware jig, in accordance with one or more arrangements; the view showing the jig having a rail with outer block assemblies, a center block, and an end stop attached thereto.

FIG. 53 shows a right elevation view of an extended length hardware jig, in accordance with one or more arrangements; the view showing the jig having a rail with an outer block assembly and an end stop attached thereto.

FIG. 54 shows a left elevation view of an extended length hardware jig, in accordance with one or more arrangements; the view showing the jig having a rail with an outer block assembly and an end stop attached thereto.

FIG. 55 shows a front perspective exploded view of an extended length hardware jig, in accordance with one or more arrangements; the view showing the jig having a rail with outer block assemblies, a center block, rail connectors, and an end stop.

FIG. 56 shows a front elevation view of an extended length hardware jig, in accordance with one or more arrangements; the view showing the jig having a rail with outer block assemblies and a center block attached thereto.

FIG. 57 shows a front perspective view of an extended length hardware jig, in accordance with one or more arrangements; the view showing the jig having a rail with outer block assemblies and a center block attached thereto.

FIG. 58 shows a rear perspective view of a rail of an extended length hardware jig, in accordance with one or more arrangements; the view showing the rail having a channel formed by an upper and lower protrusion on the back side of the rail.

FIG. 59 shows a side elevation view of a rail of an extended length hardware jig, in accordance with one or more arrangements; the view showing the rail having a channel formed by an upper and lower protrusion on the back side of the rail.

FIG. 60 shows a front exploded view of a rail connector of an extended length hardware jig, in accordance with one or more arrangements; the view showing the rail connector having a plurality of holes configured to receive a plurality of fasteners.

FIG. 61 shows a front perspective view of an outer block assembly of an extended length hardware jig, in accordance with one or more arrangements; the view showing the outer block assembly having a body configured to receive a rail and an extension member attached thereto.

FIG. 62 shows a front elevation view of an outer block assembly of an extended length hardware jig, in accordance with one or more arrangements; the view showing the outer block assembly having a body and an extension member attached thereto.

FIG. 63 shows a rear perspective view of an outer block assembly of an extended length hardware jig, in accordance with one or more arrangements; the view showing the outer block assembly having a body configured to receive a rail and an extension member attached thereto.

FIG. 64 shows a top elevation view of an extension member of an outer block assembly of an extended length hardware jig, in accordance with one or more arrangements; the view showing the extension member having a fastener configured to attach the extension member to the body at a predetermined position along the extension member.

FIG. 65 shows an exploded view of an outer block assembly of an extended length hardware jig, in accordance with one or more arrangements; the view showing the outer block assembly having a body configured to receive a rail and an extension member attached thereto.

FIG. 66 shows a front elevation view of a pair of outer block assemblies and a center block of an extended length hardware jig, in accordance with one or more arrangements; the view showing the center block having a window, a drill aperture, and a fastener attached thereto.

FIG. 67 shows a front perspective view of a center block of an extended length hardware jig, in accordance with one or more arrangements; the view showing the center block having a window, a drill aperture, and an opening configured to receive a rail.

FIG. 68 shows an exploded view of a center block of an extended length hardware jig, in accordance with one or more arrangements; the view showing the center block having a fastener configured to secure the center block to a rail.

FIG. 69 shows a front perspective view of an end stop of an extended length hardware jig, in accordance with one or more arrangements; the view showing the end stop having an opening configured to receive a rail and a fastener.

FIG. 70 shows a rear perspective view of an end stop of an extended length hardware jig, in accordance with one or more arrangements; the view showing the end stop having an opening configured to receive a rail and a fastener.

FIG. 71 shows a perspective view of an extended length hardware jig engaging a workpiece, in accordance with one or more arrangements; the view showing a pair of outer assemblies and an end stop engaging edges of the workpiece.

FIG. 72 shows a front elevation view of an extended length hardware jig engaging a workpiece, in accordance with one or more arrangements; the view showing a drill drilling a hole through a drill aperture in an outer block assembly.

FIG. 73 shows a perspective view of an extended length hardware jig engaging a workpiece, in accordance with one or more arrangements; the view showing a drill drilling a hole through a drill aperture in an outer block assembly.

### DETAILED DESCRIPTION OF THE DISCLOSURE:

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer”, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc. ” is defined as “et cetera” and indicates the inclusion of all other elements belonging to the same group of the preceding items, in any “and/or”combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively” or “operably”, such as when used as “operatively connected” or “operably engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of cabinet doors and drawer faces. However, the embodiments are not so limited. It is appreciated that the embodiments may be adapted for use in other applications which may be improved by the disclosed structures, arrangements and/or methods. The system is merely shown and described as being used in the context of cabinet doors and drawer faces for ease of description and as one of countless examples.

### EXTENDED LENGTH HARDWARE JIG SYSTEM

With reference to the figures, an extended length hardware jig system 10 (or simply “system 10”) is presented. System 10 is formed of any suitable size, shape, and design and is configured to engage a workpiece, such as a cabinet door or drawer face, and help to accurately locate and drill sets of holes on such workpieces, and such holes are typically located relatively long distances from each other. In the arrangement shown, as one example, system 10 has a front side 12, a back side 14, opposing ends 16 (or simply “ends 16”), a top side 18, and a bottom side 20. In the arrangement shown, as one example, system 10 includes a rail 22, outer block assemblies 24, center block 26, and an end stop 28, among other components as described herein. While system 10 has been described according to the arrangements shown, as one example, any combination or arrangement may be used and is hereby contemplated for use.

### Rail 22:

In the arrangement shown, as one example, system 10 includes rail 22. Rail 22 is formed of any suitable size, shape, and design and is configured to extend across a length of a workpiece, operably connect various components of system 10, and allow various components of system 10 to move along rail 22. In the arrangement shown, as one example, rail 22 has a top side 30, a bottom side 32, opposing ends 34, and a front side 36, and a back side 38.

In the arrangement shown, as one example, rail 22 is formed primarily of a metallic material such as aluminum, steel, chromium, or any other metallic material, alloy, and/or composite thereof. Alternatively, rail 22 may be formed of a non-metallic material such as a plastic material, a fiberglass material, or any other non-metallic material and/or composite thereof.

In the arrangement shown, as one example, rail 22 is a generally elongated, rectangular member which extends between opposing ends 34. In the arrangement shown, as one example, top side 30 of rail 22 is a generally rectangular, flat and planar surface which extends a length between opposing ends 34 and a width between front side 36 and back side 38. In the arrangement shown, as one example, bottom side 32 is also a generally rectangular, flat and planar surface which extends a length between opposing ends 34 and a width between front side 36 and back side 38.

In the arrangement shown, as one example, each opposing end 34 is a generally rectangular, flat and planar surface which extends a width between front side 36 and back side 38 and a height between top side 30 and bottom side 32. In the arrangement shown, as one example, each opposing end 34 has an opening which coincides with channel 42 in the back side 38 of rail 22.

In the arrangement shown, as one example, front side 36 of rail 22 is a generally rectangular, flat and planar surface which extends a length between opposing ends 34 and a height between top side 30 and bottom side 32. In the arrangement shown, as one example, front side 36 includes indicia 40. In the arrangement shown, as one example, indicia 40 shows measurements of length. In the arrangement shown, as one example, indicia 40 includes measurements of inches (with markings every 1/16^{th} of an inch) and millimeters, however indicia 40 may display any other unit of measurement. In the arrangement shown, as one example, the indicia 40 at the midpoint between the opposing ends 34 of rail 22 is 0, and the indicia 40 on either side of the midpoint notes the distance from the midpoint. In the arrangement shown, as one example, the midpoint between opposing ends 34 of rail 22 is configured to align with the midpoint between opposing ends of a workpiece and, in this arrangement as one example, indicia 40 indicates to the user of system 10 how far a given spot along rail 22 is from the midpoint of the workpiece.

In the arrangement shown, as one example, back side 38 of rail 22 is a generally rectangular, flat and planar surface which extends a length between opposing ends 34 and a height between top side 30 and bottom side 32. In the arrangement shown, as one example, back side 38 of rail 22 includes channel 42, an upper protrusion 44, and a lower protrusion 46. In the arrangement shown, as one example, channel 42, upper protrusion 44, and lower protrusion 46 are configured to allow a rail connector 48 to be inserted into a portion of rail 22 in order to connect adjacent pieces of rail 22.

In the arrangement shown, as one example, channel 42 is an empty space in rail 22 which is configured to receive one or more rail connectors 48 therein. In the arrangement shown, as one example, channel 42 extends from back side 38 inward a distance towards front side 36. In the arrangement shown, as one example, channel 42 extends a distance between opposing ends 34 of rail 22, and channel 42 extends a height from near the bottom side 32 to near the top side 30 of rail 22.

In the arrangement shown, as one example, upper protrusion 44 forms a part of the back side 38 of rail 22 and extends downward relative to the top of channel 42. In the arrangement shown, as one example, lower protrusion 46 also forms a part of back side 38 of rail 22 and extends upward relative to the bottom of channel 42. In the arrangement shown, as one example, upper protrusion 44 and lower protrusion 46 do not meet, however they form an outer barrier which is configured to engage with rail connectors 48 and prevent the rail connectors 48 from falling out of channel 42 in rail 22.

In the arrangement shown, as one example, rail 22 is formed of multiple pieces that are connected or assembled to one another via rail connectors 48. In the arrangement shown, as one example, multiple pieces may be added or taken away from rail 22 in order for rail 22 to extend various lengths depending on the length of a workpiece. In the arrangement shown, as one example, adjacent pieces of rail 22 are configured to be connected by inserting a portion of a rail connector 48 within the channel 42 of one piece of rail 22, then inserting the remainder of such rail connector 48 within the channel 42 of the other piece of rail 22, then pushing the pieces of rail 22 together until they meet, then inserting fasteners, such as set screws, into holes 50 of rail connector 48 and tightening such fasteners until rail connector 48 is securely and frictionally engaged with each piece of rail 22. In this way, the pieces of rail 22 are connected to one another via rail connectors 48.

In the arrangement shown, as one example, rail connectors 48 are generally elongated, rectangular members which have a feature on a side of the rail connector 48 which is configured to match the size and shape of the channels 42 in rails 22, thereby allowing the rail connectors 48 to be inserted into the channels 42 of rails 22 and still be accessible from the back side 14 of system 10. In the arrangement shown, as one example, rail connectors 48 also have a number of holes 50. Holes 50 are formed of any suitable size, shape, and design and are configured to receive and hold fasteners, such as set screws, therein in order to operably connect rail connectors 48 to pieces of rail 22. In this arrangement, as one example, the rail connectors 48 provide stability and rigidity to rail 22 by preventing lateral movement of the pieces of rail 22 relative to one another, and also by helping reduce bending and rotation of rail 22.

While rail 22 and its various components have been described according the arrangement shown, as one example, it will be understood by those skilled in the art that any other configuration of rail 22 and its various components may be used in order to extend across a length of a workpiece, operably connect various components of system 10, and allow various components of system 10 to move along rail 22.

As mentioned herein, in the arrangement shown, as one example, multiple pieces may be added or taken away from rail 22 in order for rail 22 to extend various lengths depending on the length of a workpiece. In the arrangement shown, as one example, the various pieces of rail 22 all fit together and are connected using the rail connectors 48 as described above. Once the user of system 10 has achieved the correct length of rail 22, the user can then place and position various other components of system 10 onto rail 22, starting with an outer block assembly 24.

### Outer Block Assemblies 24:

In the arrangement shown, as one example, system 10 includes outer block assemblies 24. Outer block assemblies 24 are formed of any suitable size, shape, and design and are configured to move along rail 22, engage an edge of a workpiece, and allow a user to accurately position and drill holes in the workpiece. In the arrangement shown, as one example, outer block assemblies 24 include an extension member 54 and a drill guide block 56.

### Extension Member 54:

In the arrangement shown, as one example, outer block assemblies 24 includes an extension member 54. Extension member 54 is formed of any suitable size, shape, and design and is configured to engage an edge of a workpiece and allow the user to move the drill guide block 56 in order to accurately position and drill holes in the workpiece. In the arrangement shown, as one example, extension member 54 has a front member 60, a back member 62, a top member 64, a bottom member 66, opposing ends 68, and an open center 70.

In the arrangement shown, as one example, extension member 54 is formed of a single, unitary member that is formed in a manufacturing process such as machining, extrusion, forming, additive manufacturing, or the like to form a unitary and monolithic member. Alternatively, extension member 54 may be formed of multiple pieces that are connected or assembled to one another through bolting, screwing, welding, friction fitting, or the like. In the arrangement shown, as one example, extension member 54 is formed primarily of a metallic material such as steel, aluminum, chromium, or any other metallic material, alloy, and/or composite thereof. Alternatively, extension member 54 may be formed of a non-metallic material such as a plastic material, a fiberglass material, or any other non-metallic material and/or composite thereof.

In the arrangement shown, as one example, front member 60 is a generally rectangular, flat and planar member which extends a height between top member 64 and bottom member 66 and a width between opposing ends 68. In the arrangement shown, as one example, front member 60 also includes indicia 72. In the arrangement shown, as one example, indicia 72 shows measurements of length. In the arrangement shown, as one example, indicia 72 includes measurements of inches (with markings every 1/16^{th} of an inch) and millimeters, however indicia 72 may display any other unit of measurement. In the arrangement shown, as one example, indicia 72 indicates the distance from the edge of the workpiece that the outer block assembly 24 is engaged with. Said another way, the extension member 54 operably engages an edge of a workpiece and the indicia 72 on the front member 60 of extension member 54 indicates the distance from the edge of the workpiece. This allows a user to easily and accurately locate and drill holes in the workpiece.

In the arrangement shown, as one example, back member 62 is a generally rectangular, flat and planar member which extends a height between top member 64 and bottom member 66 and a width between opposing ends 68. In the arrangement shown, as one example, bottom member 66 is also a generally rectangular, flat and planar member which extends a depth between front member 60 and back member 62 and a width between opposing ends 68 of extension member 54.

In the arrangement shown, as one example, top member 64 is a generally rectangular, flat and planar member which extends a depth between opposing front and back sides and a width between opposing ends 68 of extension member 54. In the arrangement shown, as one example, top member 64 extends outward past front member 60 and back member 62 in order for top member 64 to engage an edge of a workpiece when back member 62 or front member 60 are placed up against a work surface of the workpiece. In this way, top member 64 operably engages an edge of the workpiece in order to properly engage and position system 10 relative to the workpiece.

In the arrangement shown, as one example, opposing ends 68 of extension member 54 are generally formed of the opposing left and right ends of front member 60, back member 62, top member 64, and bottom member 66. In the arrangement shown, as one example, an open center 70 extends through engagement member 54 from one opposing end 68 through the other opposing end 68. In the arrangement shown, as one example, the open center 70 extending through engagement member 54 allows rail 22 to extend through engagement member 54. In the arrangement shown, as one example, the open center 70 also allows for the drill guide block 56 of outer block assemblies 24 to extend through open center 70, as well as move up and down along the height of the engagement member 54 in order for the drill guide block 56 to be properly positioned to accurately drill holes in a workpiece.

### Drill Guide Block 56:

In the arrangement shown, as one example, outer block assembly 24 includes drill guide block 56. Drill guide block 56 is formed of any suitable size, shape, and design and is configured to be properly positioned such that a drill or awl may pass through drill guide block 56 in order to accurately drill holes in a workpiece. In the arrangement shown, as one example, drill guide block 56 includes a main body 74, an end plate 76, a first thumb screw 78, and a second thumb screw 80.

### Main Body 74:

In the arrangement shown, as one example, drill guide block 56 includes main body 74. Main body 74 is formed of any suitable size, shape, and design and is configured to extend through the open center 70 of extension member 54, operably connect to end plate 76, accurately indicate locations of a hole to be drilled, and allow a drill or awl to pass through drill guide block 56 in order to drill a hole in a workpiece. In the arrangement shown, as one example, main body 74 has a front side 82, a back side 84, a top side 86, a bottom side 88, a first end 90, a second end 92, a recessed portion 94, an opening 96, a drill aperture 98, a rift 100, and screw holes 102.

In the arrangement shown, as one example, main body 74 is formed of a single, unitary member that is formed in a manufacturing process such as machining, casting, forming, additive manufacturing, or the like to form a unitary and monolithic member. Alternatively, main body 74 may be formed of multiple pieces that are connected or assembled to one another through bolting, screwing, welding, friction fitting, or the like. In the arrangement shown, as one example, main body 74 is formed primarily of a metallic material such as aluminum, steel, chromium, or any other metallic material, alloy, and/or composite thereof. Alternatively, main body 74 may be formed of a non-metallic material such as a plastic material, a fiberglass material, or any other non-metallic material and/or composite thereof.

In the arrangement shown, as one example, main body 74 is a generally rectangular member, extending a length between first end 90 and second end 92, a depth between front side 82 and back side 84, and a height between top side 86 and bottom side 88. In the arrangement shown, as one example, main body 74 also includes a recessed portion 94. Recessed portion 94 is formed of any suitable size, shape, and design and is configured to allow main body 74 to extend through the open center 70 of extension member 54. In the arrangement shown, as one example, at approximately the midpoint between first end 90 and second end 92, the depth of main body 74 narrows to a depth capable of fitting through the open center 70 of extension member 54.

In the arrangement shown, as one example, main body 74 also includes an opening 96. Opening 96 is formed of any suitable size, shape, and design and is configured to allow rail 22 to be extended through main body 74 and drill guide block 56. In the arrangement shown, as one example, opening 96 extends through main body 74 from the first end 90 to the second end 92.

In the arrangement shown, as one example, main body 74 includes a drill aperture 98. Drill aperture 98 is formed of any suitable size, shape, and design and is configured to allow a drill bit, awl, or other tool to extend through main body 74 in order to drill a hole in a workpiece. In the arrangement shown, as one example, drill aperture 98 extends through main body 74 from the front side 82 to the back side 84 of main body 74. In the arrangement shown, as one example, when the drill guide block 56 is properly positioned, the center of the drill aperture 98 will be accurately and properly placed in order to drill a hole in the workpiece.

In the arrangement shown, as one example, main body 74 includes a rift 100. Rift 100 is formed of any suitable size, shape, and design and is configured to indicate to provide a reference point in order for the user to determine where the center of the drill aperture 98 in main body 74 is located, thus allowing the user to properly position drill aperture 98 in order to accurately drill holes in a workpiece. In the arrangement shown, as one example, rift 100 is cut-out of the main body 74 on the first end 90 of main body 74. In the arrangement shown, as one example, the rift 100 includes ledges 104. Ledges 104 are configured to align with the center of the drill aperture 98 and are configured to easily allow the user to determine where the center of a hole will be located when drilled. In the arrangement shown, as one example, when drill guide block 56 is positioned on rail 22, the rift 100 allows the user to view indicia 40 on the front side 36 of rail 22 the user can align the ledges 104 with the desired length measurement, thereby allowing the user to properly and accurately place the drill guide block 56 to perform a drilling operation on the workpiece.

In the arrangement shown, as one example, main body 74 also includes screw holes 102. Screw holes 102 are formed of any suitable size, shape, and design and are configured to allow first thumb screw 78 and second thumb screw 80 to pass into main body 74 in order to operably join other parts of drill guide block 56 to main body 74. In the arrangement shown, as one example, main body 74 includes two screw holes 102. In the arrangement shown, as one example a first screw hole 102 is positioned on the bottom side 88 of main body 74 and is configured to allow first thumb screw 78 to extend through the screw hole 102 in order to engage rail 22 when rail 22 extends through main body 74. When first thumb screw 78 is passed through the screw hole 102 on the bottom side 88 of main body 74, the main body 74 is operably and securely connected to rail 22.

In the arrangement shown, as one example, a second screw hole 102 is positioned on the second end 92 of main body 74. In the arrangement shown, as one example, the second screw hole 102 is configured to receive second thumb screw 80 therein in order to operably connect end plate 76 to main body 74 and to connect and secure drill guide block 56 to extension member 54.

End Plate 76: In the arrangement shown, as one example, drill guide block 56 includes end plate 76. End plate 76 is formed of any suitable size, shape, and design and is configured to operably connect to main body 74 in order to secure drill guide block 56 to extension member 54. In the arrangement shown, as one example, end plate 76 is a generally rectangular, planar member which extends a distance between opposing ends 106, a depth between opposing front and back sides 108, and a height between a top side 110 and a bottom side 112. In the arrangement shown, as one example, end plate 76 includes an opening 114. Opening 114 is configured to allow rail 22 to extend through end plate 76, thereby allowing drill guide block 56 to slide along rail 22.

In the arrangement shown, as one example, end plate 76 includes a screw hole 116. Screw hole 116 is formed of any suitable size, shape, and design and is configured to allow second thumb screw 80 of drill guide block 56 to extend therethrough in order to enter into a corresponding screw hole 102 in main body 74.

In the arrangement shown, as one example, end plate 76 extends a depth between opposing front and back sides 108 which is approximately the same as the depth between front member 60 and back member 62 of extension member 54. In the arrangement shown, as one example, when second thumb screw 80 is extended through screw hole 116 of end plate 76 and into the corresponding screw hole 102 in main body 74 and then tightened, end plate 76 and main body 74 are operably connected. In this arrangement, as one example, the opposing front and back sides 108 of end plate 76 are generally collinear with the front member 60 and back member 62 of extension member 54. Additionally, in this arrangement as one example, when the second thumb screw 80 is tightened, one of the opposing ends 106 of the end plate 76 is pushed into tight engagement with an opposing end 68 of extension member 54 and the other opposing end 68 of the extension member 54 is pushed into close and tight engagement with a portion of main body 74.

With end plate 76 and main body 74 in close and tight engagement with extension member 54, extension member 54 and drill guide block 56 are operably connected to each other. Either before or after extension member 54 and drill guide block 56 are operably connected, rail 22 may be extended through the opening 114 of end plate 76, the opening 96 of main body 74, and the open center 70 of extension member 54. When rail 22 is extended through outer block assemblies 24 in this manner, the first thumb screw 78 may be extended through the appropriate screw hole 102 in main body 74 and tightened, first thumb screw 78 will cause main body 74 and rail 22 to press against each other, thereby tightly securing outer block assemblies 24 in place along rail 22.

While outer block assemblies 24 and its components have been described according the arrangement shown, as one example, it will be understood by those skilled in the art that any other configuration of outer block assemblies 24 and its components may be used in order to move along rail 22, engage an edge of a workpiece, and allow a user to accurately position and drill holes in the workpiece.

In the arrangement shown, as one example, when the first of the outer block assembly 24 is positioned on rail 22, the user of system 10 can place and position one or more optional center blocks 26 onto rail 22, before positioning a second outer block assembly 24 onto rail 22.

### Center Block 26:

In the arrangement shown, as one example, system 10 includes a center block 26. Center block 26 is formed of any suitable size, shape, and design and is configured to move along rail 22 and allow a user to accurately position and drill holes in a workpiece. In the arrangement shown, as one example, there is one center block 26. In various alternative arrangements, system 10 may not have any center block 26, or system 10 may have two, three, four, five, six, seven, eight, nine, ten, or any other number of center blocks 26. In the arrangement shown, as one example, center blocks 26 have a front side 120, a back side 122, a top side 124, a bottom side 126, and opposing ends 128. In the arrangement shown, as one example, center block 26 includes an opening 130, a drill aperture 132, a window 134 with a feature 136, and screw holes 138.

In the arrangement shown, as one example, center block 26 is formed of a single, unitary member that is formed in a manufacturing process such as machining, casting, additive manufacturing, or the like to form a unitary and monolithic member. Alternatively, center block 26 may be formed of multiple pieces that are connected or assembled to one another through bolting, screwing, welding, friction fitting, or the like. In the arrangement shown, as one example, center block 26 is formed primarily of a metallic material such as steel, aluminum, chromium, or any other metallic material, alloy, and/or composite thereof. Alternatively, center block 26 may be formed of a non-metallic material such as a plastic material, a fiberglass material, or any other non-metallic material and/or composite thereof.

In the arrangement shown, as one example, center block 26 is a generally rectangular member, extending a length between opposing ends 128, a depth between front side 120 and back side 122, and a height between top side 124 and bottom side 126.

In the arrangement shown, as one example, center block 26 includes an opening 130. Opening 130 is formed of any suitable size, shape, and design and is configured to allow rail 22 to be extended through center block 26. In the arrangement shown, as one example, opening 130 extends through center block 26 from one opposing end 128 to the other opposing end 128 of center block 26.

In the arrangement shown, as one example, center block 26 includes a drill aperture 132. Drill aperture 132 is formed of any suitable size, shape, and design and is configured to allow a drill bit, awl, or other tool to extend through center block 26 in order to drill a hole in a workpiece. In the arrangement shown, as one example, drill aperture 132 extends through center block 26 from the front side 120 to the back side 122. In the arrangement shown, as one example, when the center block 26 is properly positioned, the center of the drill aperture 132 will be accurately and properly placed in order to drill a hole in the workpiece.

In the arrangement shown, as one example, center block 26 includes a window 134. Window 134 is formed of any suitable size, shape, and design and is configured to allow the user of system 10 to see the indicia 40 on rail 22 when center block 26 is positioned on rail 22, thereby allowing the user to properly position drill aperture 132 in center block 26 in order to accurately drill holes in a workpiece. In the arrangement shown, as one example, window 134 is cut out of the front side 120 of center block 26. In the arrangement shown, as one example, window 134 also includes feature 136. Feature 136 is configured to align with the center of the drill aperture 132 and is configured to easily allow the user to determine where the center of a hole will be located when drilled. In the arrangement shown, as one example, when center block 26 is positioned on rail 22, window 134 allows the user the view indicia 40 and the user can align the feature 136 with the desired measurement, thereby allowing the user to properly and accurately place the center block 26 to perform a drilling operation on the workpiece.

In the arrangement shown, as one example, center block 26 also includes a screw hole 138. Screw hole 138 is formed of any suitable size, shape, and design and is configured to allow a thumb screw 140 to pass through center block 26 in order to operably join center block 26 to rail 22. In the arrangement shown, as one example, screw hole 138 is positioned on the bottom side 126 of center block 26 and is configured to allow the thumb screw 140 to extend through the screw hole 138 in order to engage rail 22 when rail 22 extends through center block 26. When thumb screw 140 is passed through the screw hole 138 on the bottom side 126 of center block 26, the center block 26 is operably and securely connected to rail 22.

While center block 26 and its components have been described according the arrangement shown, as one example, it will be understood by those skilled in the art that any other configuration of center block 26 and its components may be used in order to move along rail 22 and allow a user to accurately position and drill holes in a workpiece.

Once the one or more center blocks 26 are placed on rail 22 (if center blocks 26 are present at all), then the other outer block assembly 24 may be placed onto rail 22 as mentioned herein. Once all center blocks 26 and outer block assemblies 24 are placed on rail 22, one or more end stops 28 may be placed on rail 22.

### End Stop 28:

In the arrangement shown, as one example, system 10 includes one or more end stops 28. End stop 28 is formed of any suitable size, shape, and design and is configured to engage an edge of a workpiece in order to secure system 10 to the workpiece during a drilling operation. In the arrangement shown, as one example, end stop 28 includes a front side 144, a back side 146, a top side 148, a bottom side 150, opposing ends 152, an opening 154, a screw hole 156, and a thumb screw 158.

In the arrangement shown, as one example, end stop 28 is formed of a single, unitary member that is formed in a manufacturing process such as machining, casting, additive manufacturing, or the like to form a unitary and monolithic member. Alternatively, end stop 28 may be formed of multiple pieces that are connected or assembled to one another through bolting, screwing, welding, friction fitting, or the like. In the arrangement shown, as one example, end stop 28 is formed primarily of a metallic material such as steel, aluminum, chromium, or any other metallic material, alloy, and/or composite thereof. Alternatively, end stop 28 may be formed of a non-metallic material such as a plastic material, a fiberglass material, or any other non-metallic material and/or composite thereof.

In the arrangement shown, as one example, end stop 28 is a generally rectangular member, extending a length between opposing ends 152, a depth between front side 144 and back side 146, and a height between top side 148 and bottom side 150.

In the arrangement shown, as one example, end stop 28 includes opening 154. Opening 154 is formed of any suitable size, shape, and design and is configured to allow rail 22 to be extended through end stop 28. In the arrangement shown, as one example, opening 154 extends through end stop 28 from one opposing end 152 to the other opposing end 152 of end stop 28.

In the arrangement shown, as one example, end stop 28 also includes a screw hole 156. Screw hole 156 is formed of any suitable size, shape, and design and is configured to allow a thumb screw 158 to pass through end stop 28 in order to operably join end stop 28 to rail 22. In the arrangement shown, as one example, screw hole 156 is positioned on the bottom side 150 of end stop 28 and is configured to allow the thumb screw 158 to extend through the screw hole 156 in order to engage rail 22 when rail 22 extends through end stop 28. When thumb screw 158 is passed through the screw hole 156 on the bottom side 150 of end stop 28, the end stop 28 is operably and securely connected to rail 22.

While end stop 28 and its components have been described according the arrangement shown, as one example, it will be understood by those skilled in the art that any other configuration of end stop 28 and its components may be used in order to engage an edge of a workpiece in order to secure system 10 to the workpiece during a drilling operation.

### In Operation:

In various arrangements, system 10 may be used by a user to accurately locate holes for large pulls on workpieces such as cabinet doors and drawer faces. In the arrangement shown, as one example, system 10 is assembled by first aligning the various pieces of rail 22, placing a portion of rail connector 48 through one piece of rail 22 and another portion of rail connector 48 through the adjacent piece of rail 22, then bring the pieces of rail 22 so that their ends meet one another. At this point, screws, such as set screws, may be threaded through various holes in the rail connector 48, thereby causing a secure engagement between rail connector 48 and the pieces of rail 22, and securing the pieces of rail 22 together. This process may be repeated in order to connect as many pieces of rail 22 as needed to form the desired length of rail 22.

Either before or after rail 22 is connected, the user must put together the outer block assemblies 24. The user may take the extension member 54, align the recessed portion 94 of main body 74 with the open center 70 of extension member 54, then insert the recessed portion 94 into the open center 70 of extension member 54. At this point, the user can move the main body 74 along the height of extension member 54 in order to position the drill guide block 56 at the proper position for the holes needed on the workpiece. Once the drill guide block 56 is properly positioned, as indicated by the indicia 72 on the front member 60 of the extension member 54, the user can then align end plate 76 such that the screw hole 116 of end plate 76 with the screw hole 102 in the second end 92 of main body 74. Once aligned, the user can bring the end plate 76 into engagement with the second end 92 of main body 74 and with an opposing end 68 of extension member 54. The second thumb screw 80 can then be threaded through the screw hole 116 of end plate 76 and into screw hole 102 in the second end 92 of main body 74, thereby connecting end plate 76 to main body 74 and bringing the drill guide block 56 (including main body 74 and end plate 76) into secured engagement with extension member 54 so that drill guide block 56 can no longer slide along the height of extension member 54. Once completed, the outer block assemblies 24 have been completed.

Once outer block assemblies 24 and rail 22 are assembled, an outer block assembly 24 can be placed onto rail 22. In order to do so, the rail 22 is aligned with and extended through the opening 114 of end plate 76 and the opening 96 of main body 74 of outer block assembly 24. Once on rail 22, the user can use the indicia 40 on the front side 36 of rail 22 to properly align the position the outer block assembly 24. The user can align the ledge 104 of main body 74 with the desired measurement, as indicated by indicia 40 and, once properly aligned, the user can thread the first thumb screw 78 through the screw hole 102 in the bottom side 88 of main body 74. Once threaded through the screw hole 102 in the bottom side 88 of main body 74, the first thumb screw 78 engages rail 22 and holds the outer block assembly 24 in place so that it can no longer move along the length of rail 22.

Once the first outer block assembly 24 is properly positioned on rail 22, one or more center blocks 26 may be positioned on rail 22. This is done by extending the rail 22 through the opening 130 of center block 26 and positioning center block 26 by aligning the feature 136 of center block 26 with the desired measurement as indicated by the indicia 40 on the front side 36 of rail 22. Once properly positioned along rail 22, thumb screw 140 can be threaded into screw hole 138 and once thumb screw 140 is threaded, thumb screw 140 engages rail 22 and holds the center block 26 in place so that it can no longer move along the length of rail 22.

Once the desired number of center blocks 26 have been positioned along rail 22, the other outer block assembly 24 may be placed onto and positioned along rail 22 as previously described herein. Once the outer block assemblies 24 and center blocks 26 have been attached to rail 22, one or more end stops 28 may be connected to rail 22, if desired. In the arrangement shown, as one example, the rail 22 may be extended through the opening 154 of end stop 28 and positioned as desired along rail 22 - typically at the edge of any workpiece system 10 is being used on. Once the end stop 28 is properly positioned, the thumb screw 158 can be threaded into screw hole 156 and once thumb screw 158 is threaded, thumb screw 158 engages rail 22 and holds the center block 26 in place so that it can no longer move along the length of rail 22. At this point, the outer block assemblies 24, center block 26 (if any), and end stops 28 (if any) are properly positioned and system 10 is ready to be used in a drilling operation. In this arrangement, the user positions system 10 such that the top member 64 of the extension member 54 on each of the outer block assemblies 24 is engaged with an edge of the workpiece.

Once properly engaged with the edge of the workpiece, the user can be sure that the drill apertures 98 each of the main bodies 74 of the outer block assemblies 24, and the drill aperture 132 in the center block 26 (if any) are accurately positioned. The user can be confident about this positioning because the dual outer block assemblies 24 provide two reference points, as opposed to one reference point, for the measurements of the holes, and also because there is no tolerance stack-up in system 10. That is, because indicia 40 and indicia 72 are provided directly by the position where the hole is to be drilled, there is only one place where tolerances come into place. Due to the multiple reference points and low tolerances due to the indicia 40 and indicia 72 on system 10, there is less dependence on factory precision and calibration. In this way, system 10 is also designed so that it is easier to manufacture and harder for errors to be built into system 10 during the manufacturing process. Because of this, once system 10 is properly set up and engaged with the workpiece, the user can confidently drive a drill, awl, or other tool through drill apertures 98 and drill aperture 132 (if present) and accurately drill holes in the workpiece, even over long pulls on things such as cabinet doors and drawer faces.

If end stop 28 is positioned against an additional edge of the workpiece, a user can quickly and accurately drill repeated holes in additional workpieces. End stop 28 permits a user to place system 10 onto a new workpiece and immediately have drill apertures 98 and drill aperture 132 (if present) positioned accurately. End stop 28 provides an additional reference point to ensure accurate repeated results. Use of end stop 28 stops a user from having to find the midpoint of the workpiece and align system 10 each time it is used if the user is drilling holes on multiple workpieces of the same dimensions.

### ALTERNATE ARRANGEMENT(S)

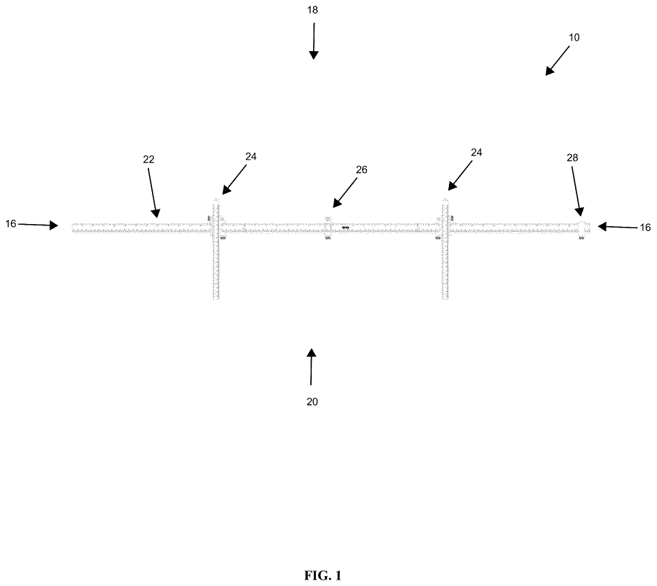

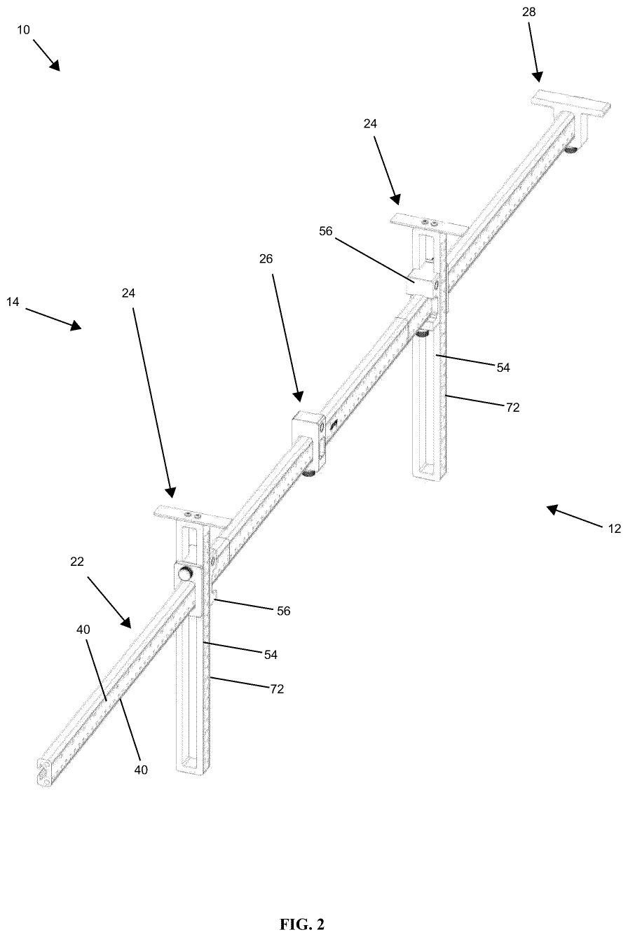

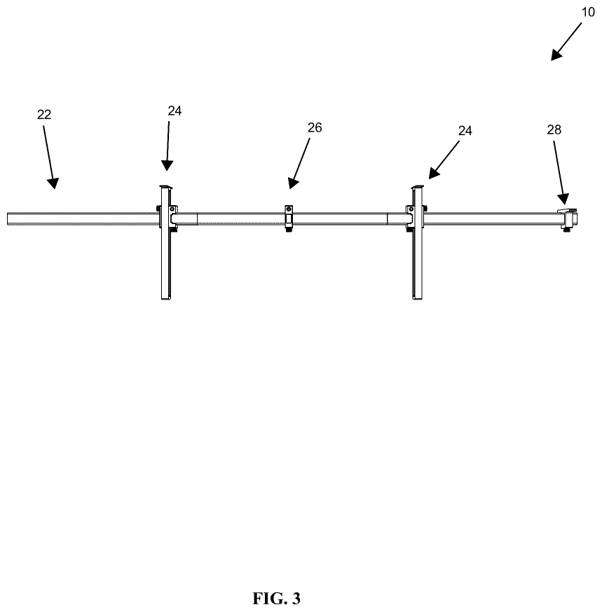

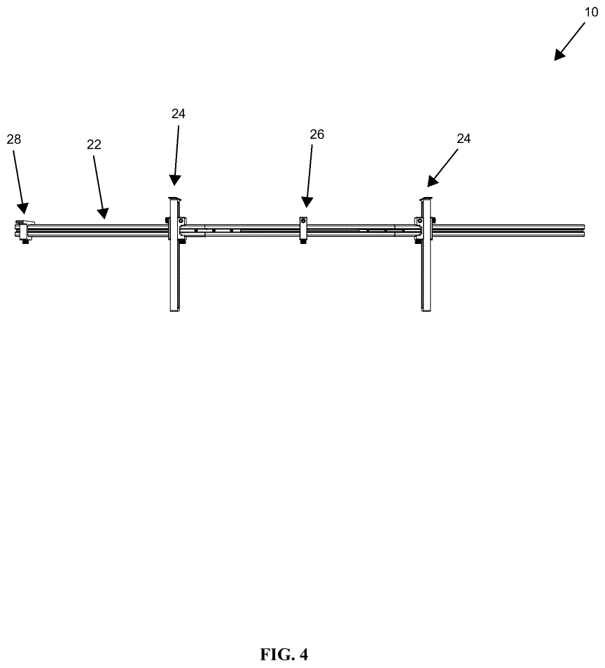

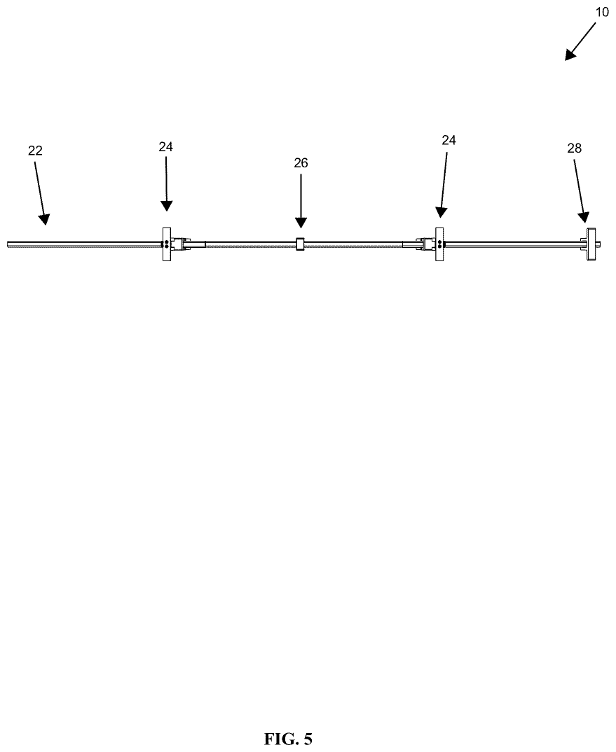

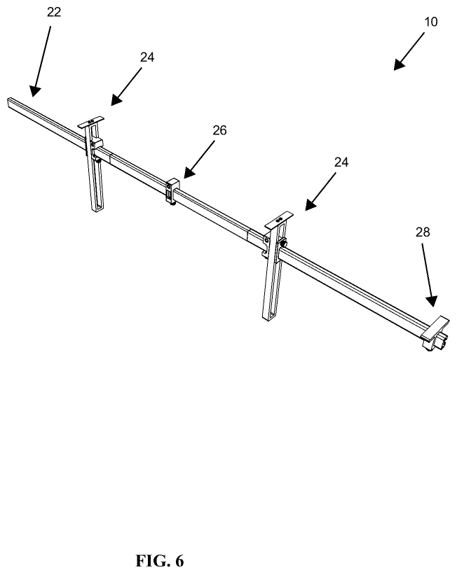

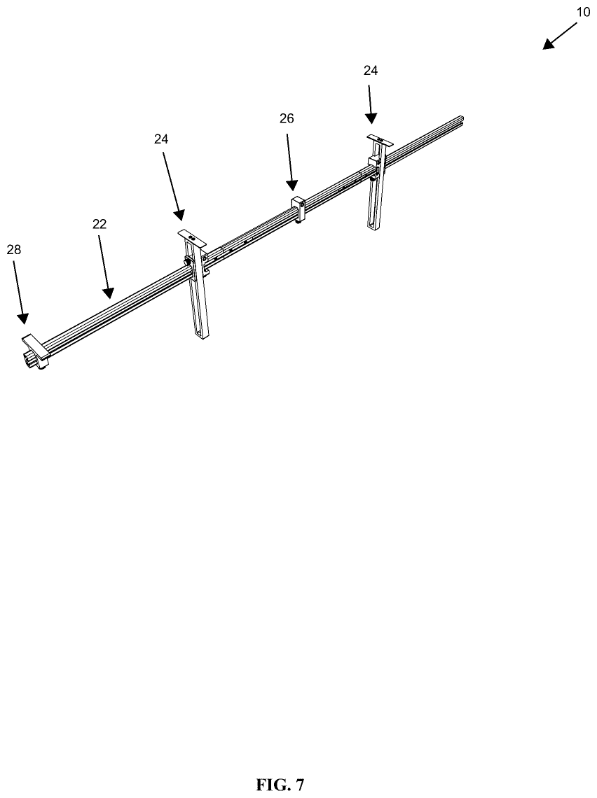

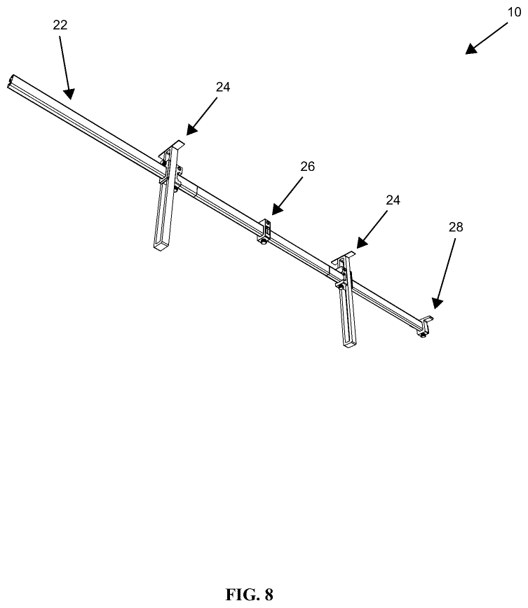

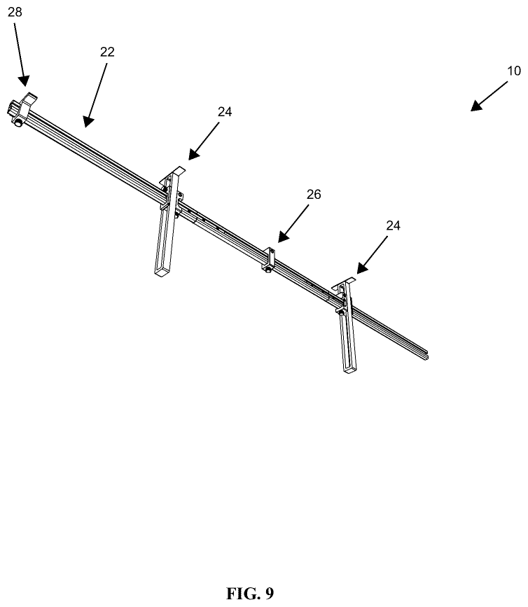

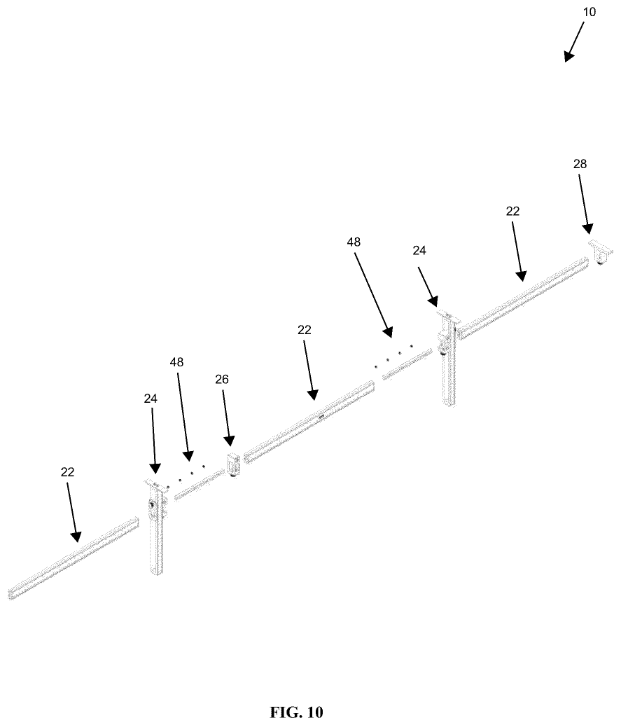

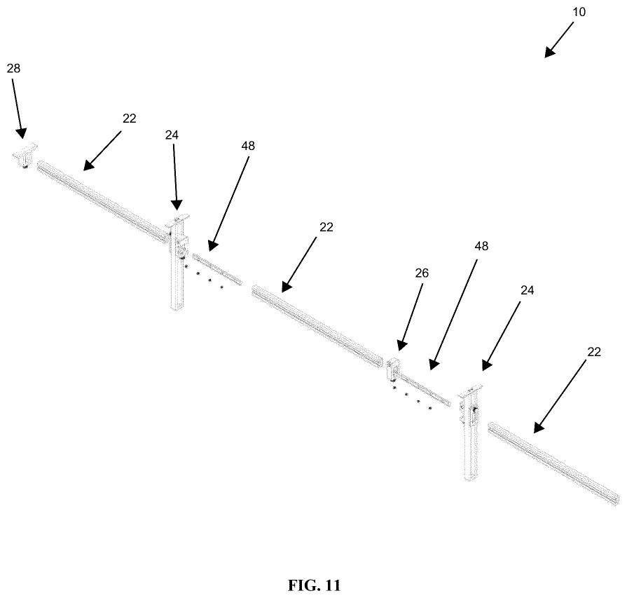

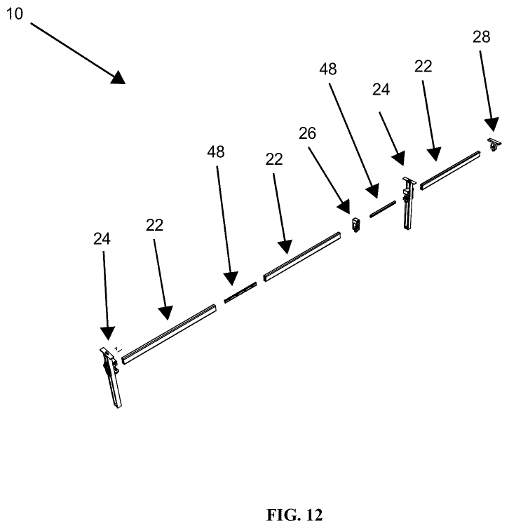

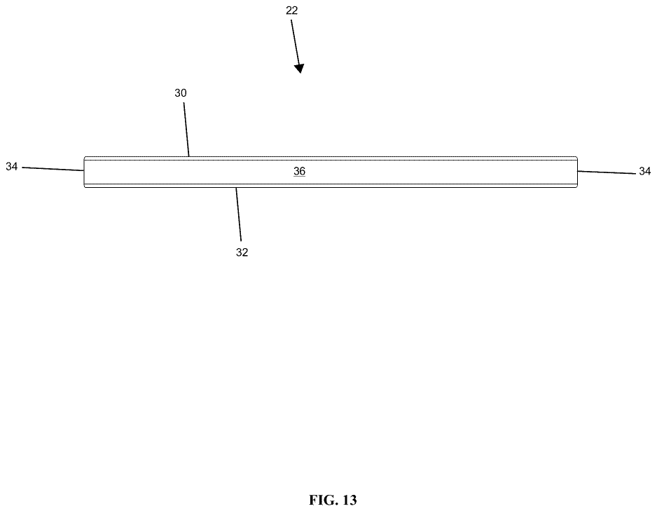

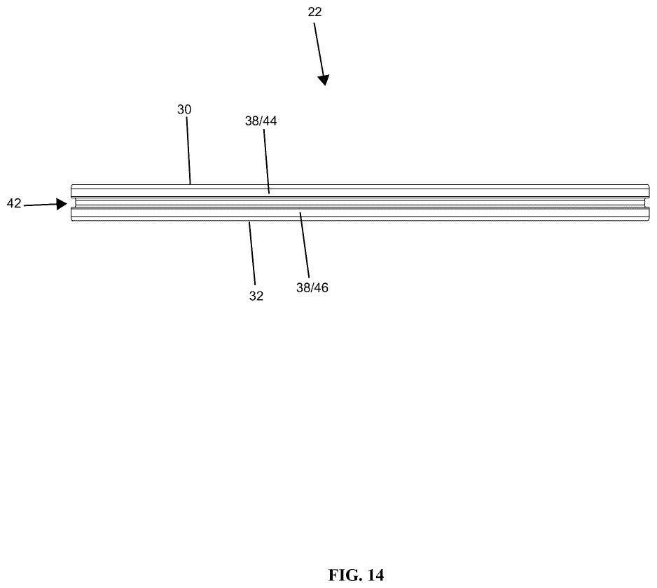

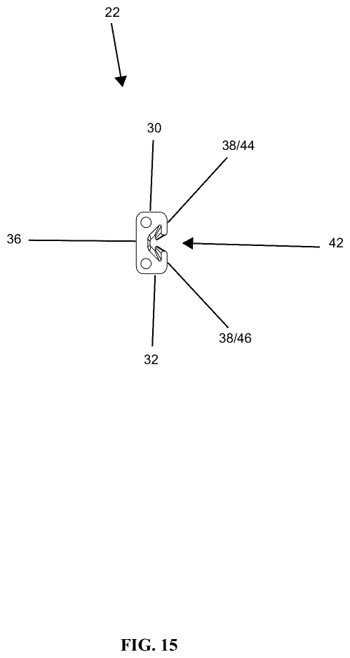

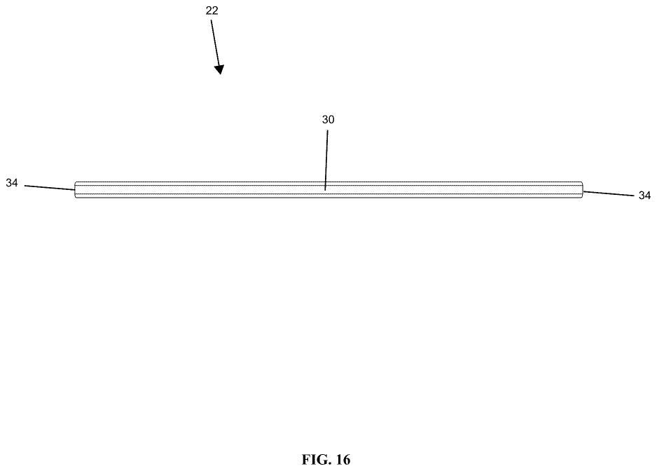

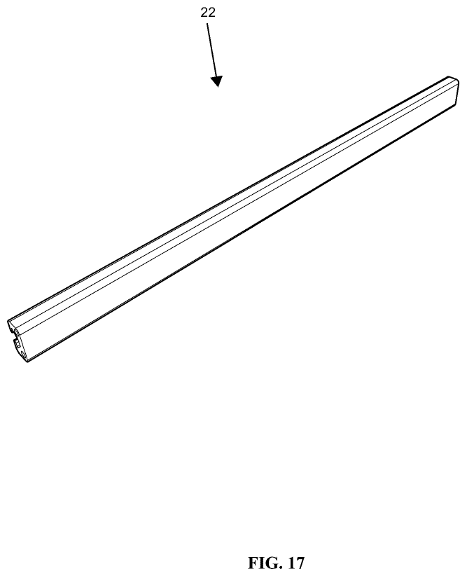

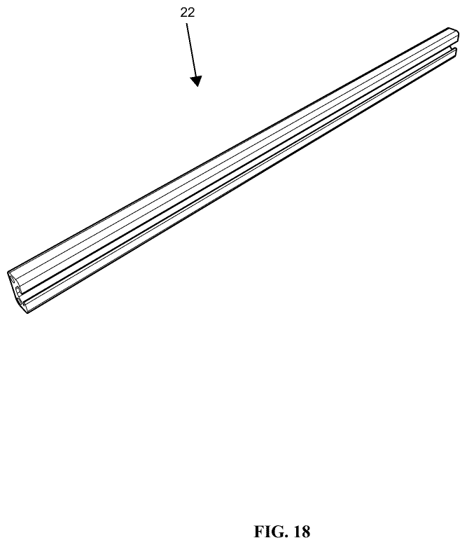

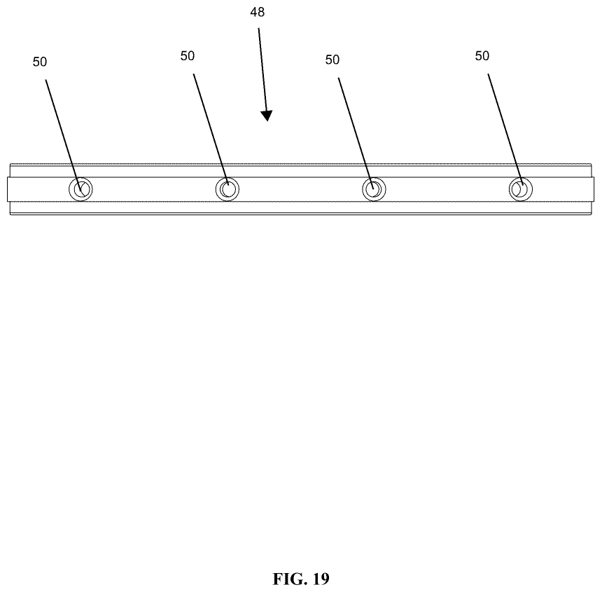

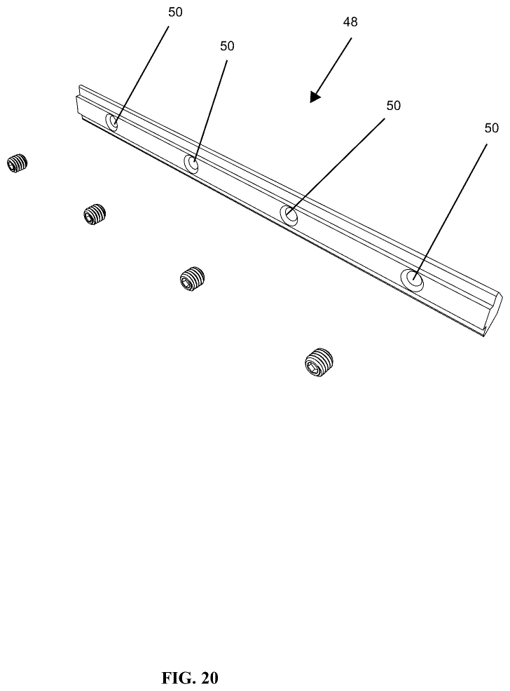

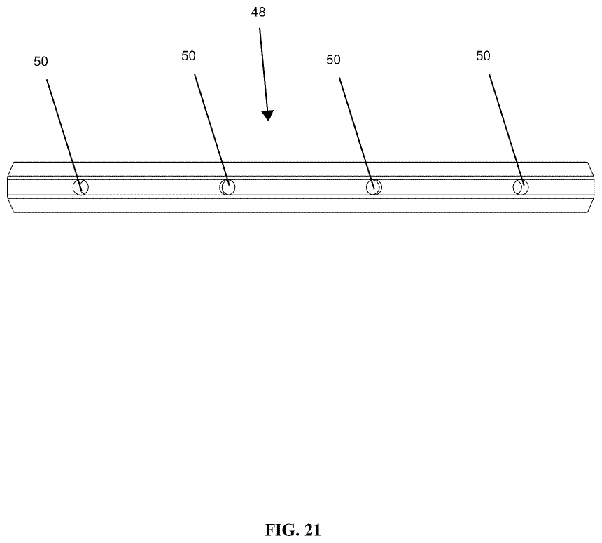

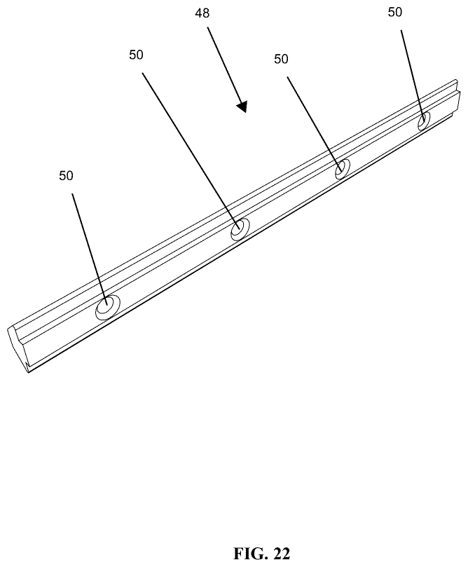

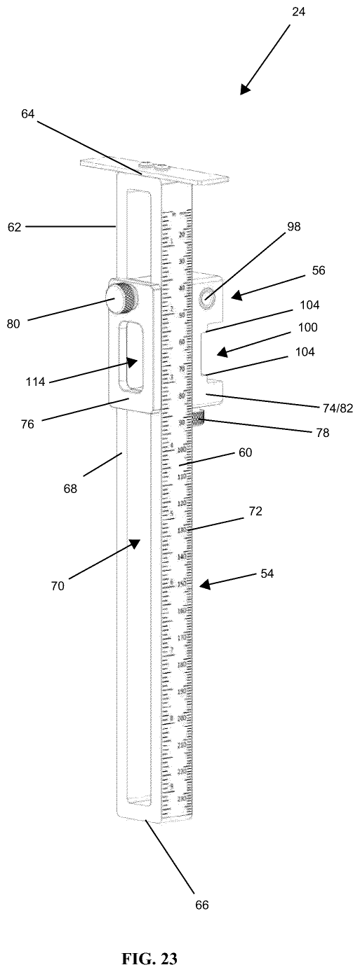

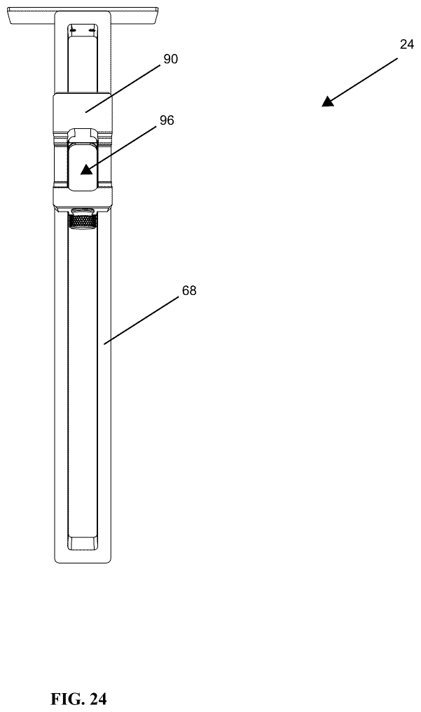

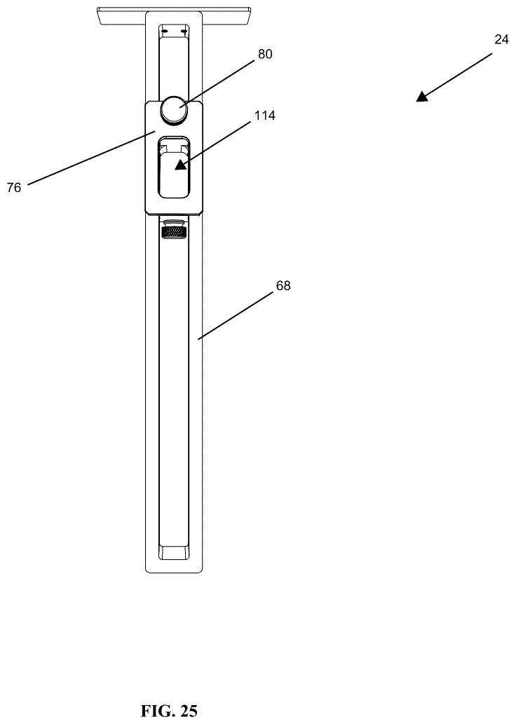

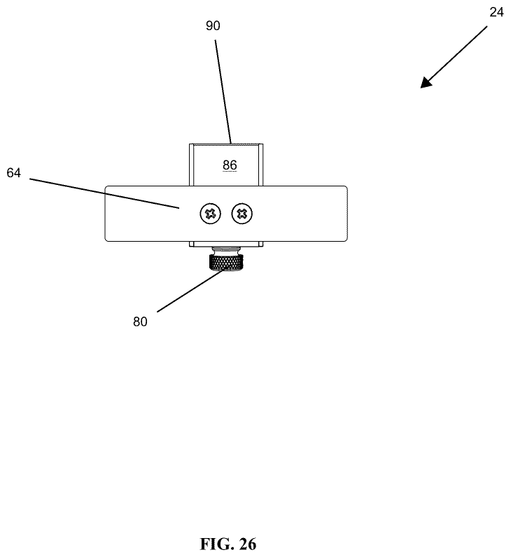

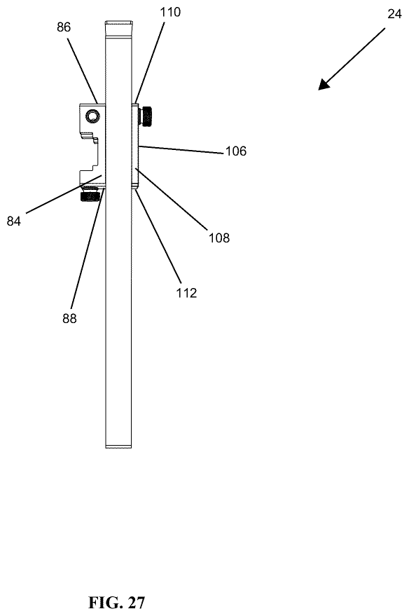

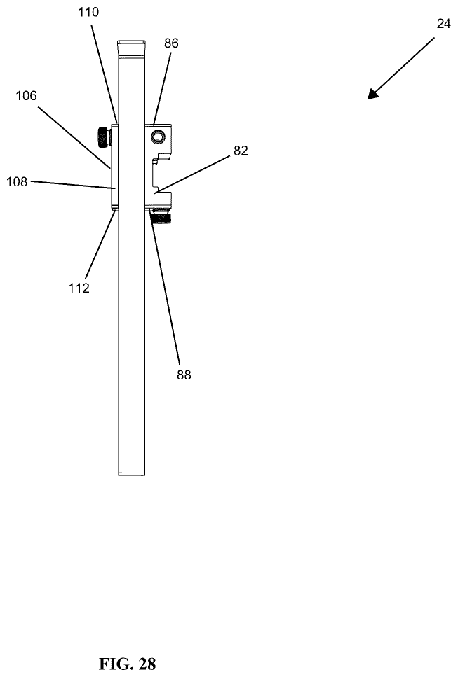

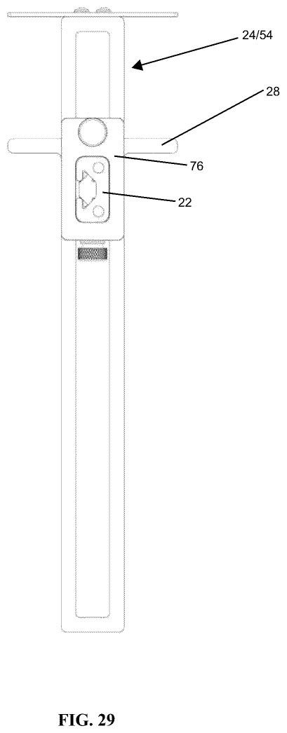

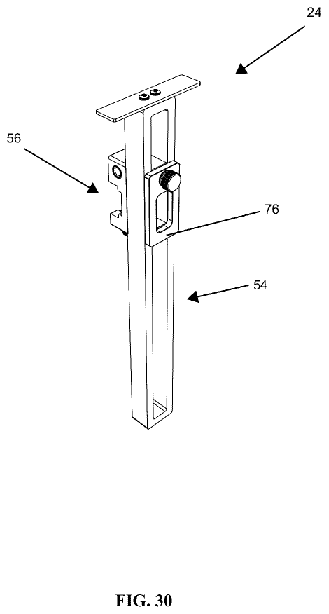

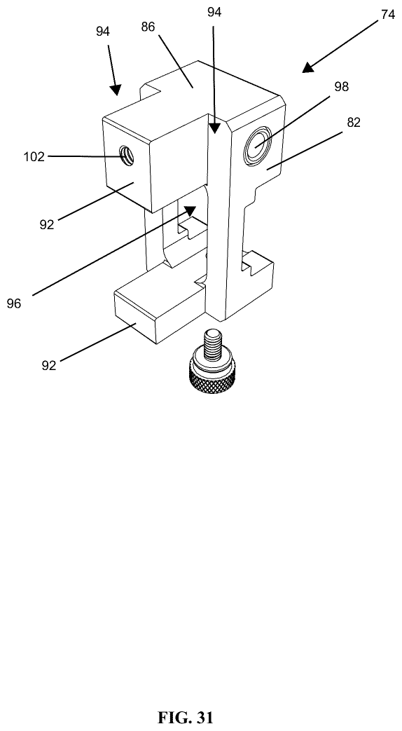

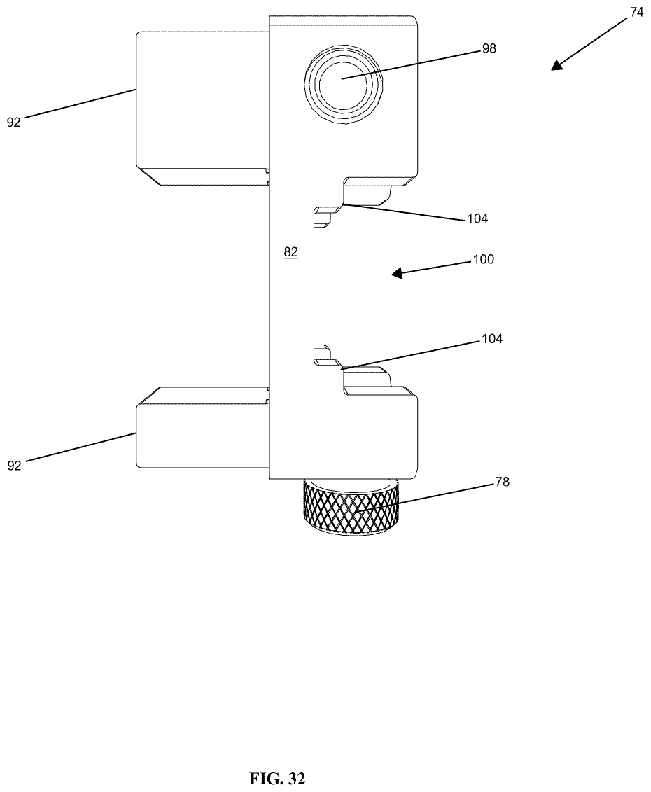

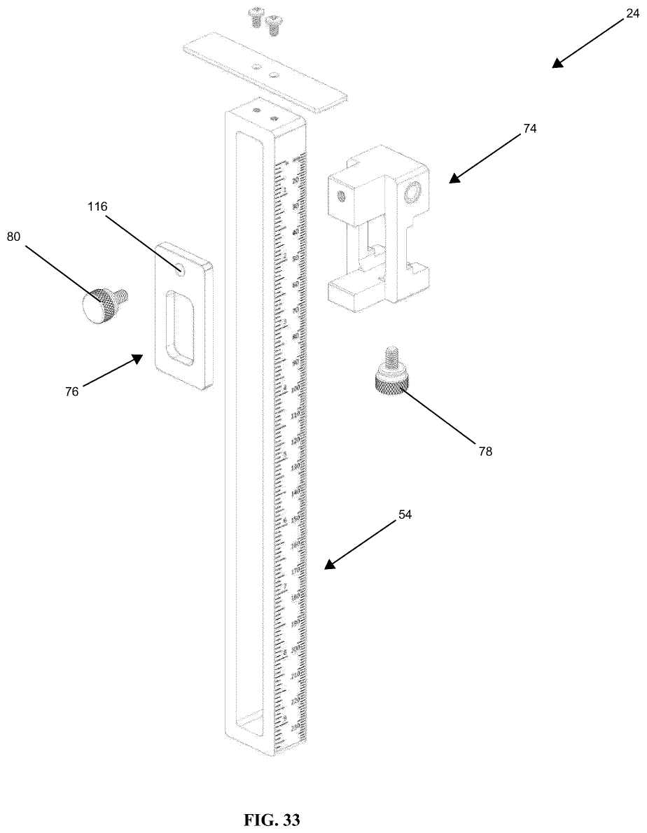

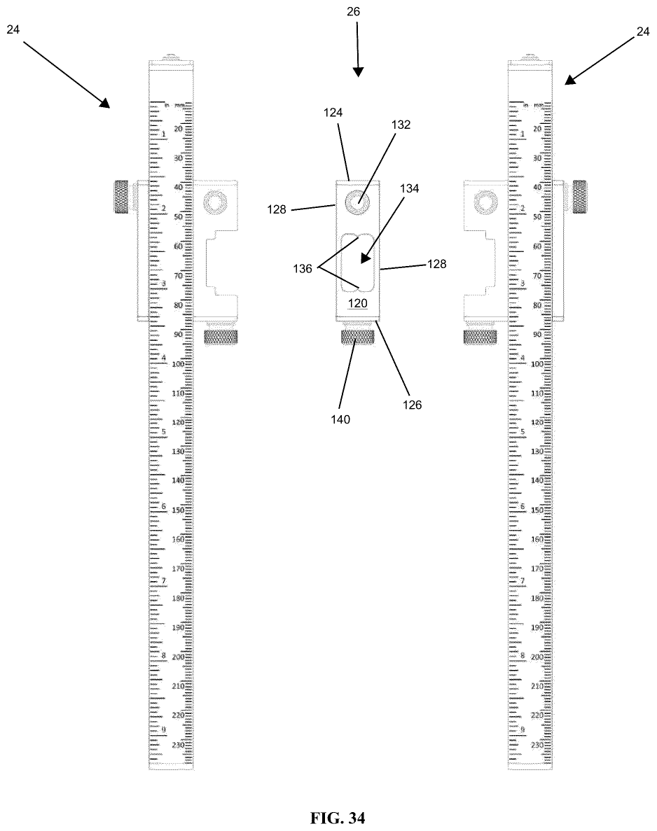

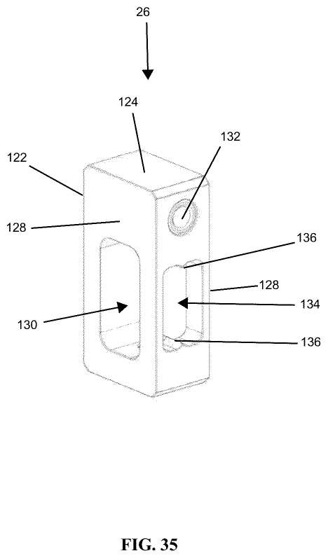

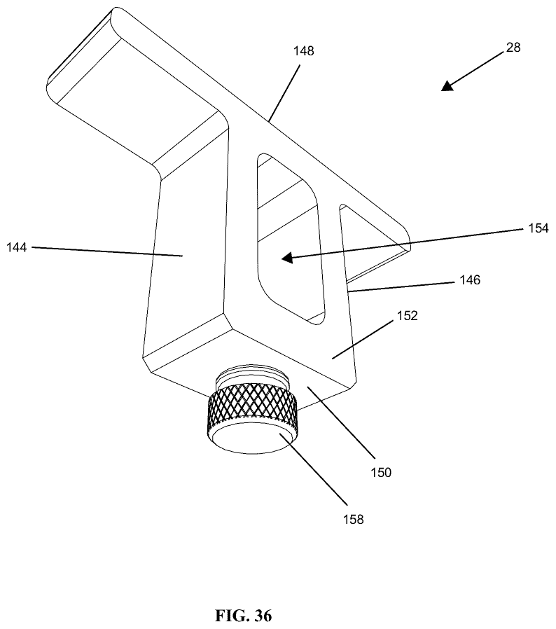

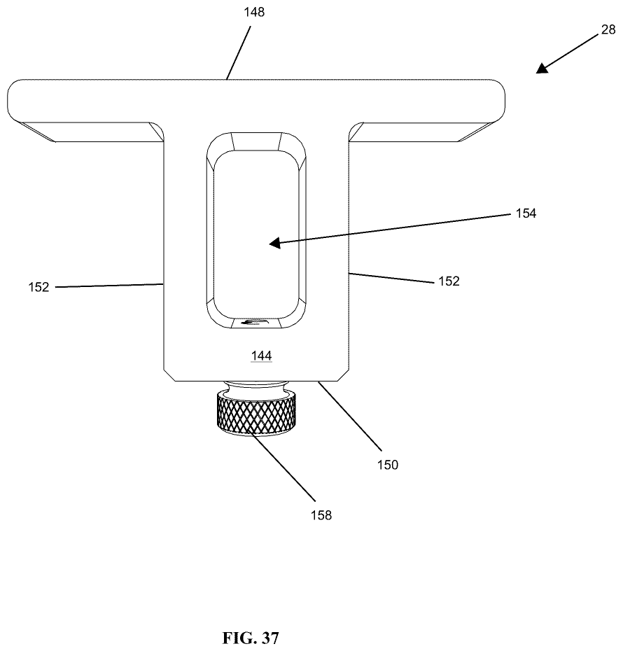

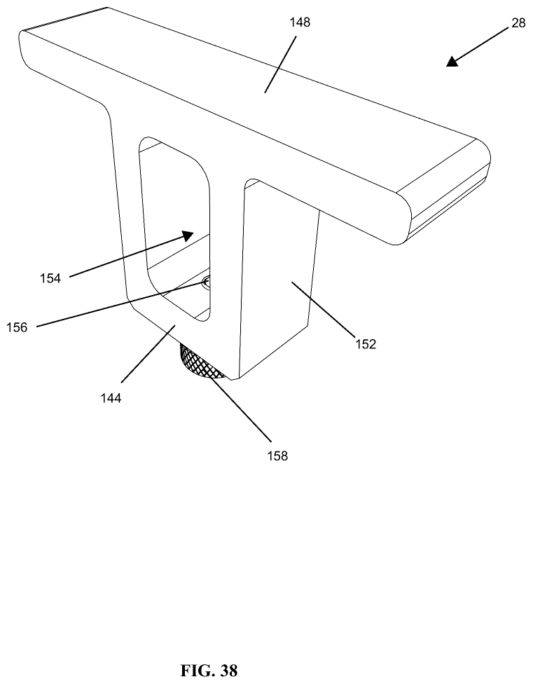

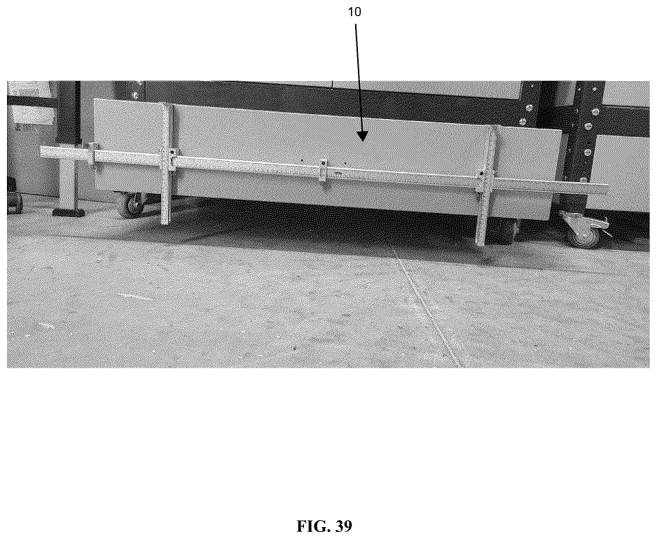

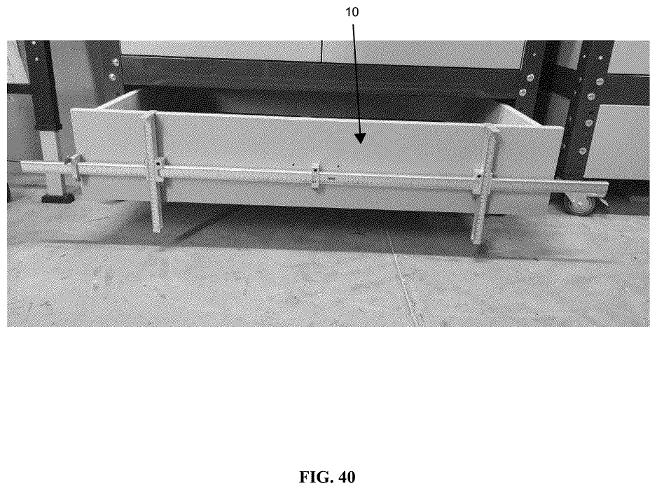

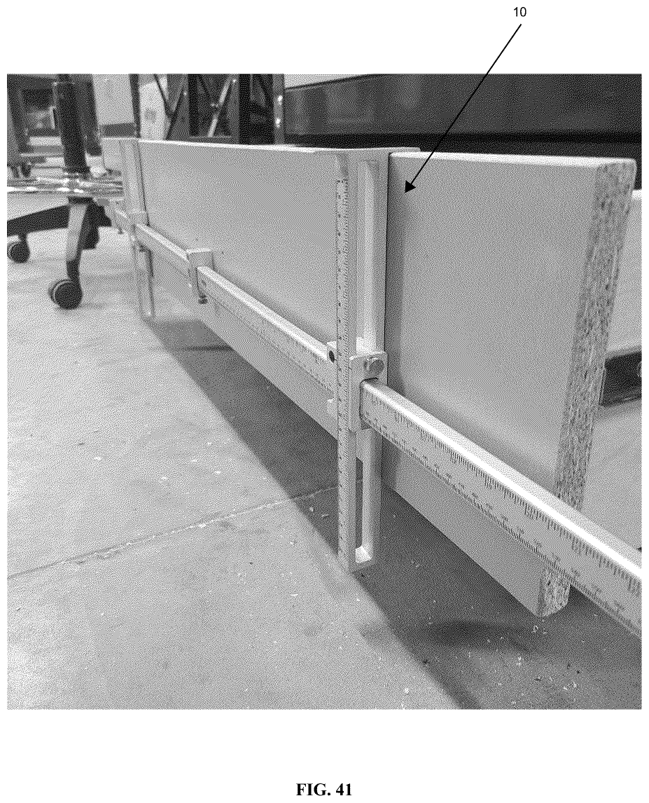

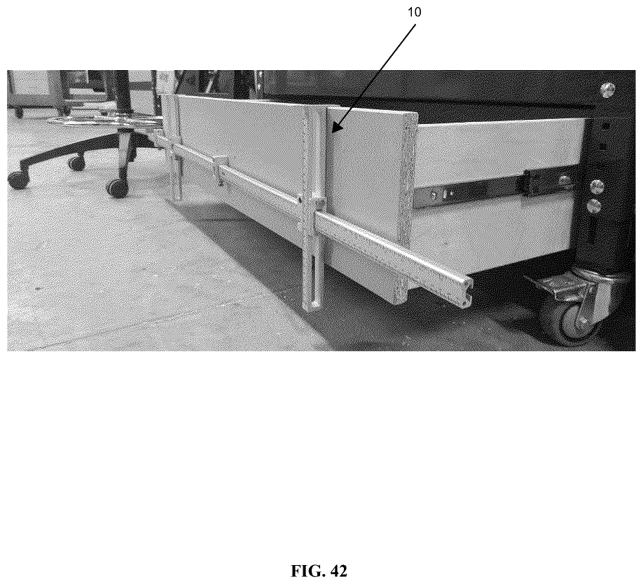

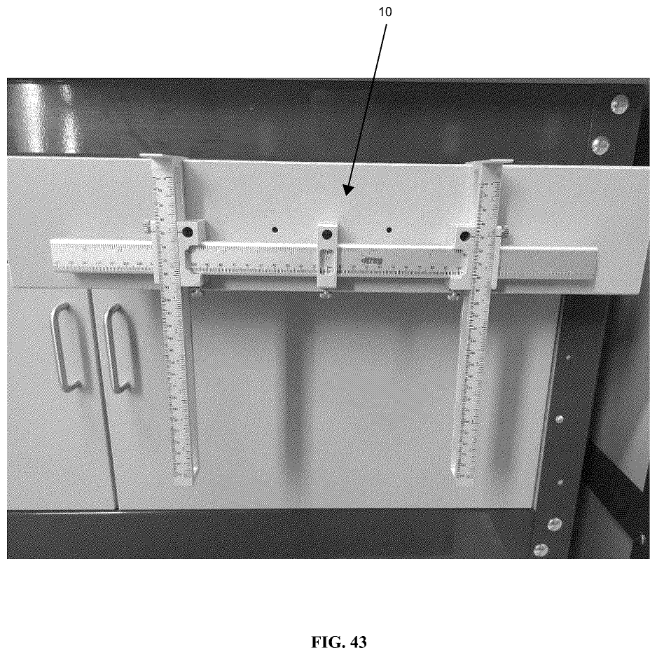

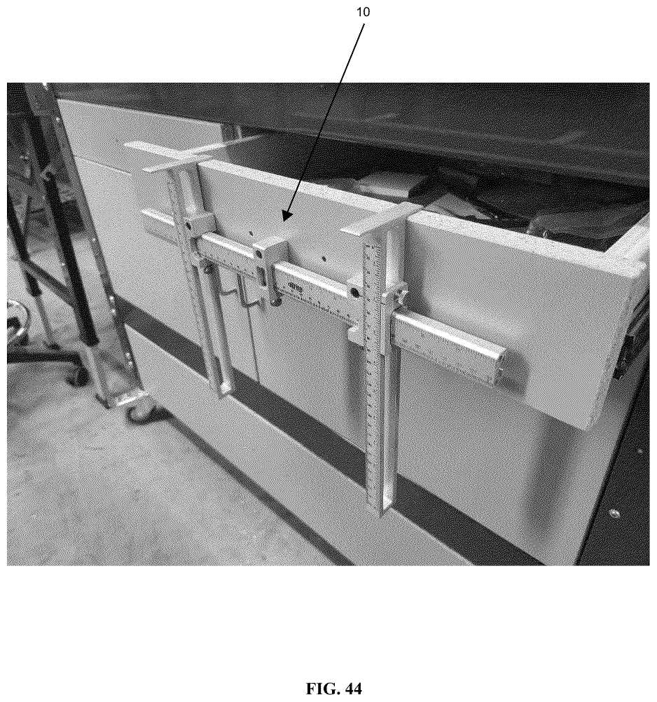

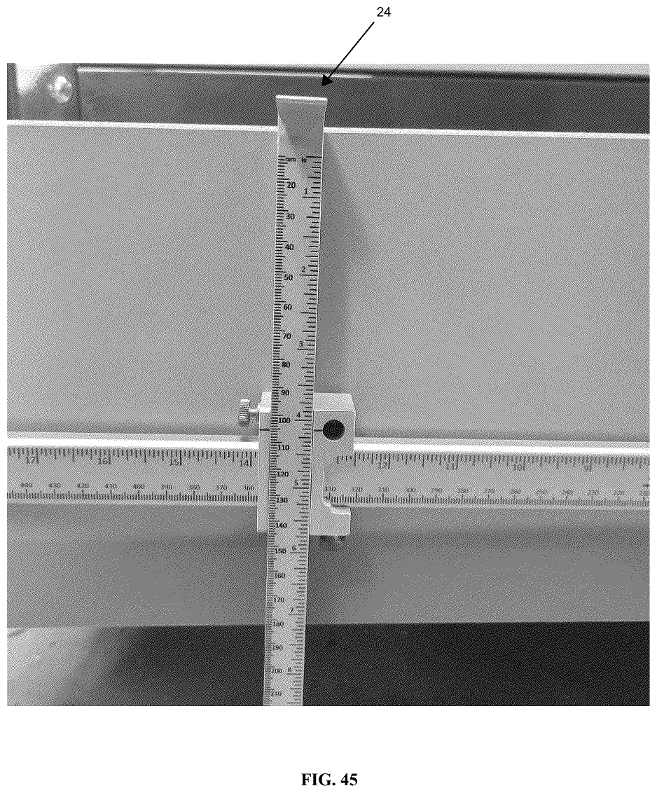

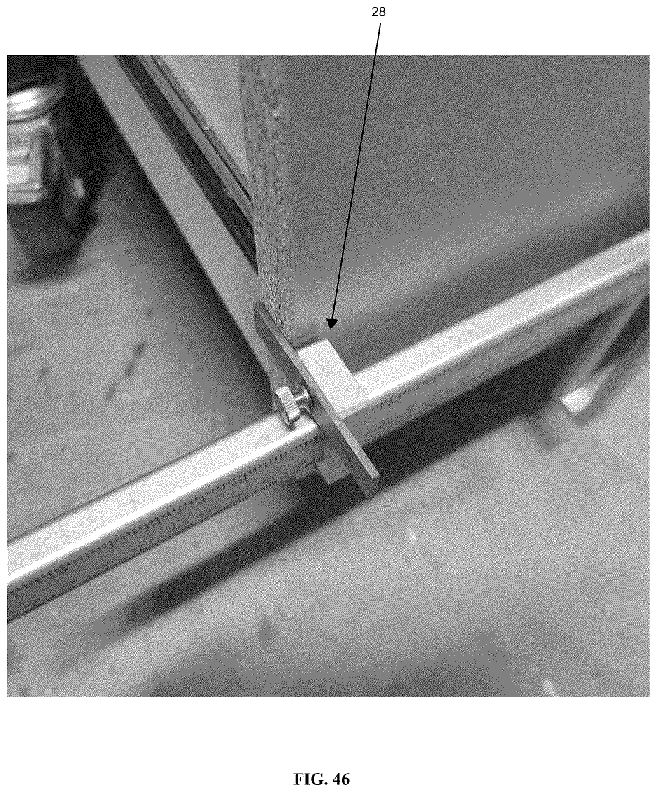

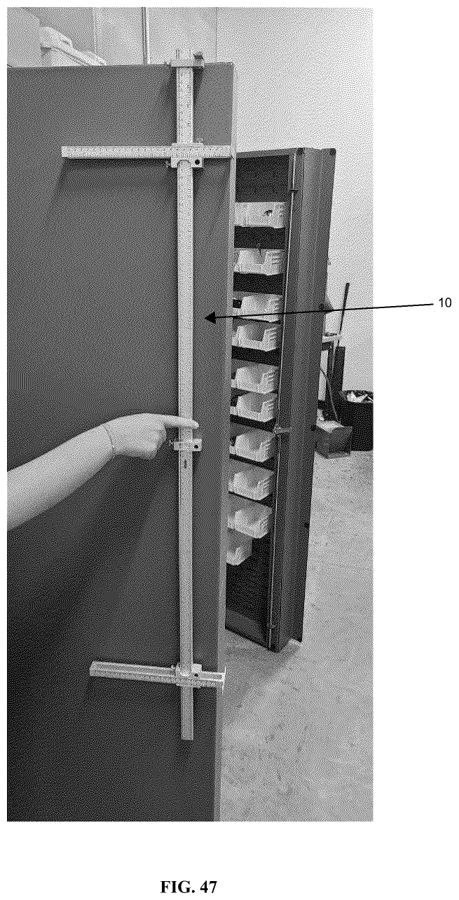

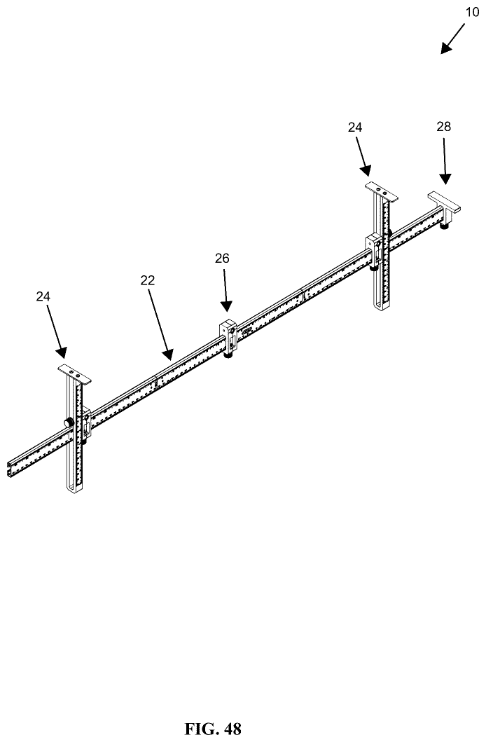

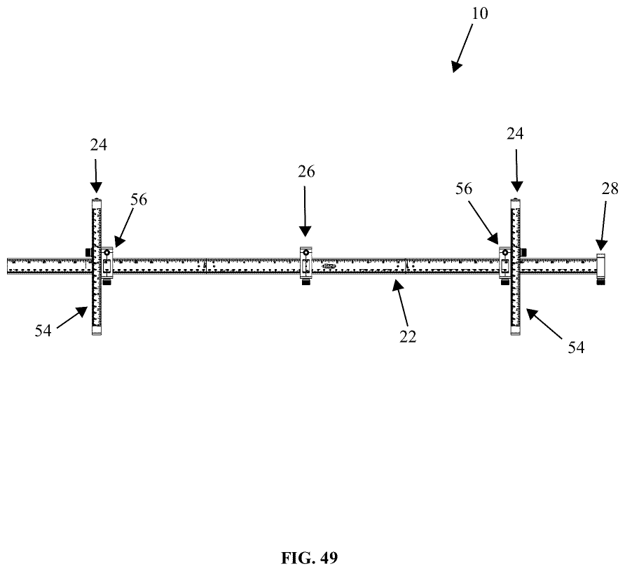

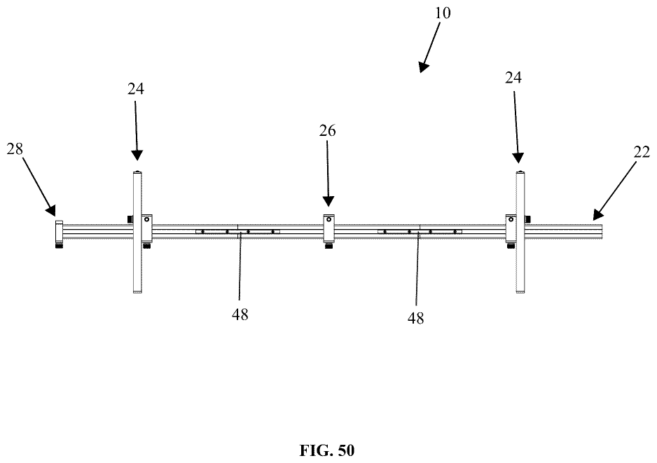

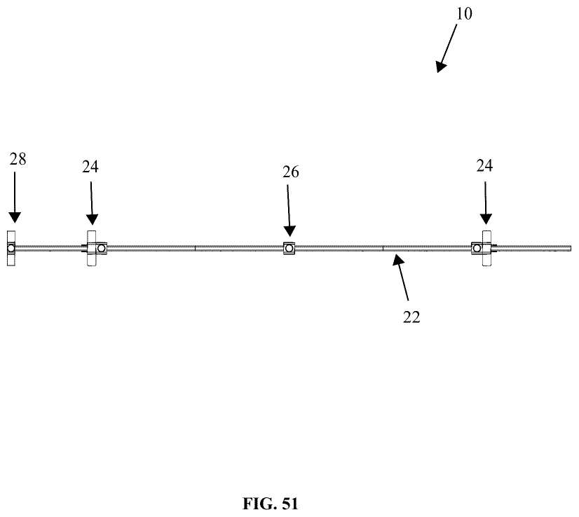

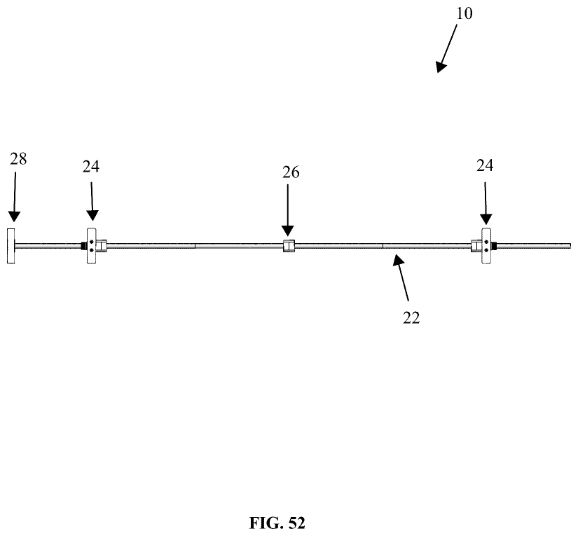

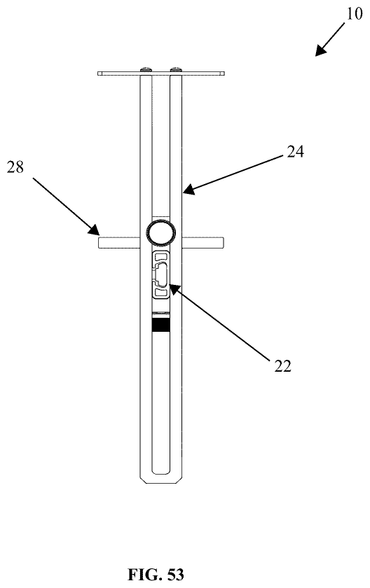

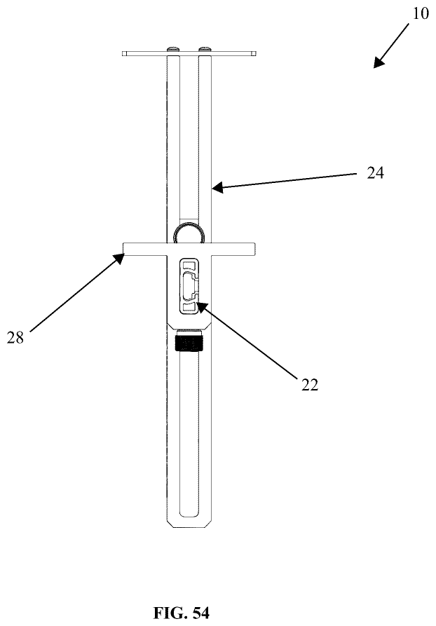

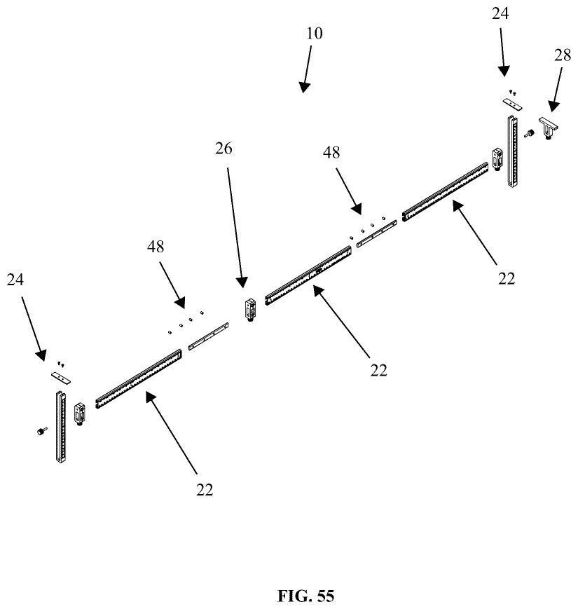

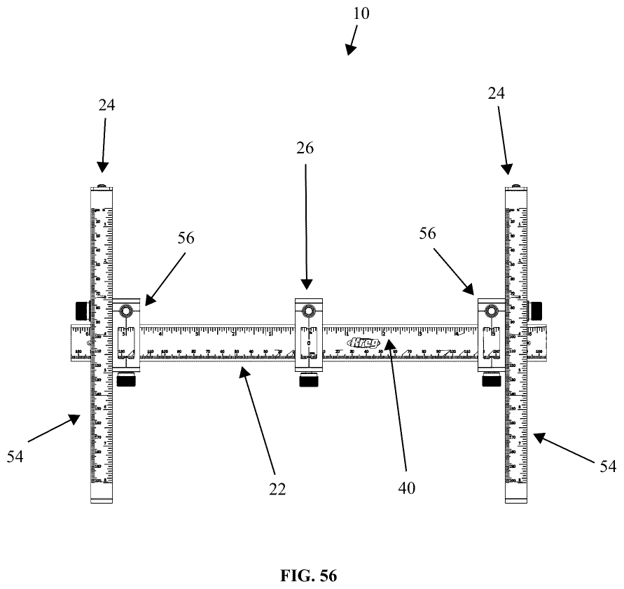

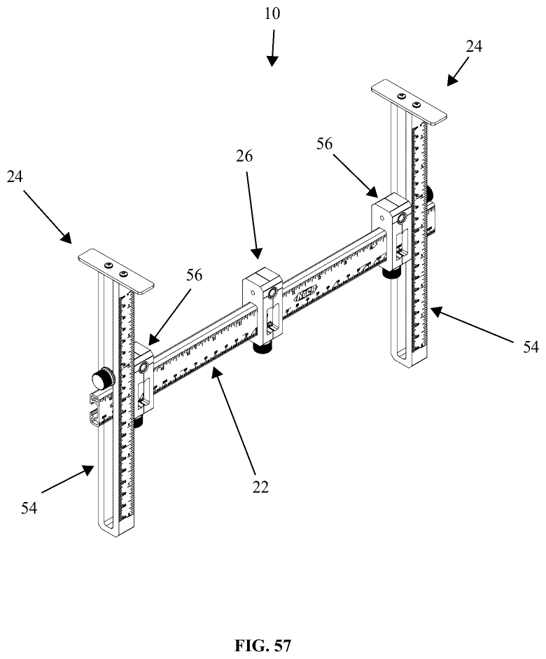

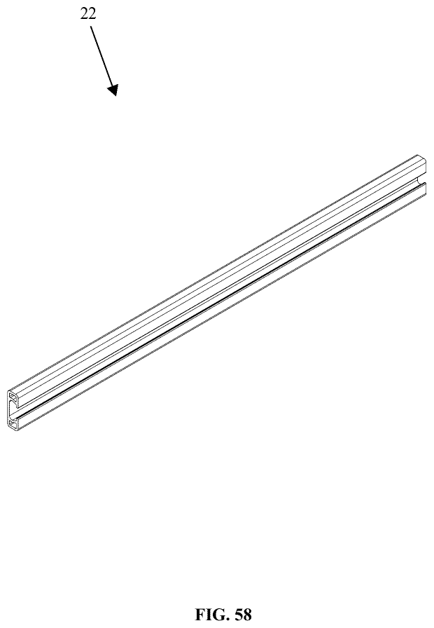

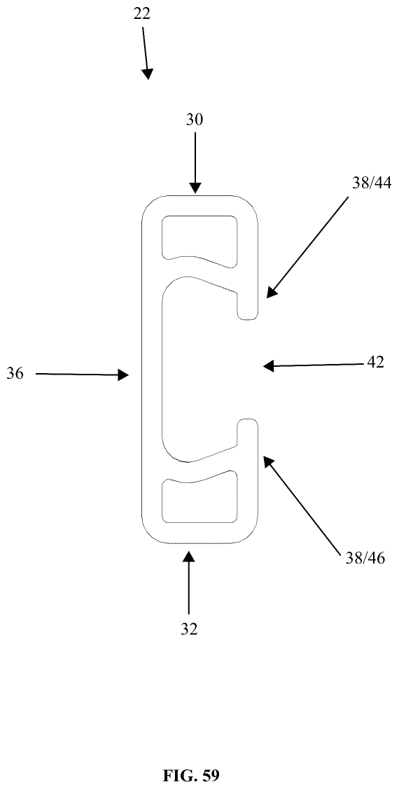

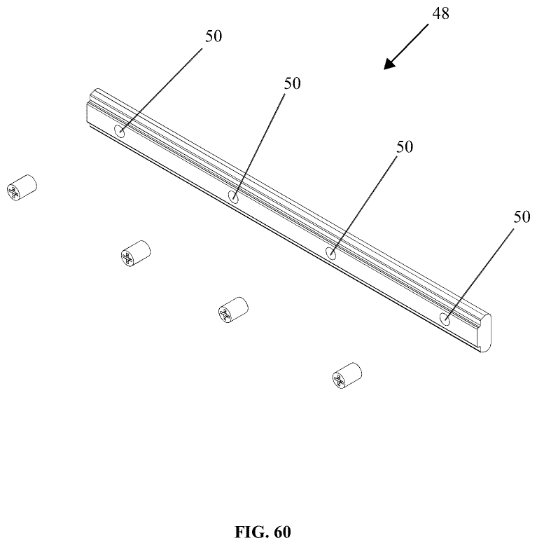

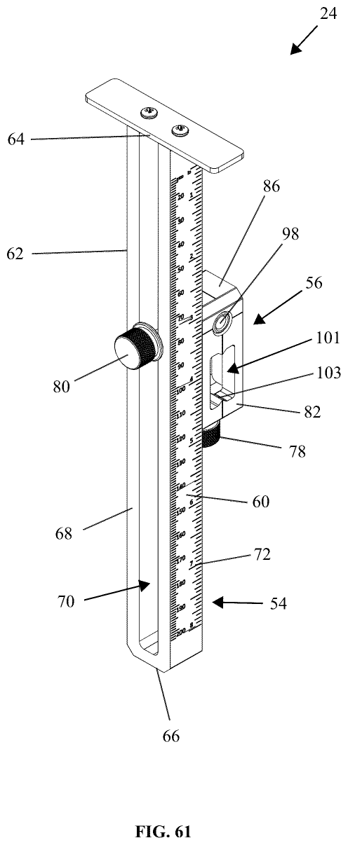

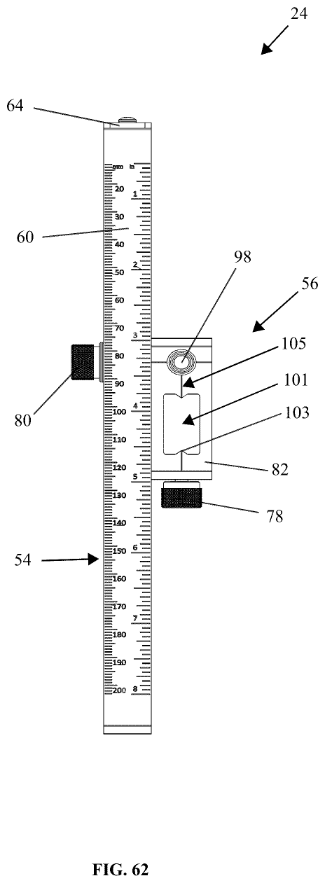

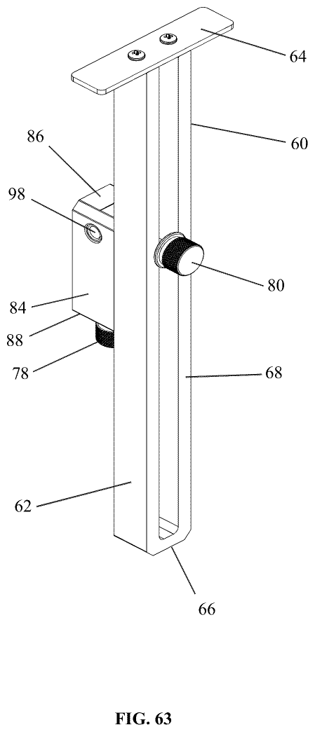

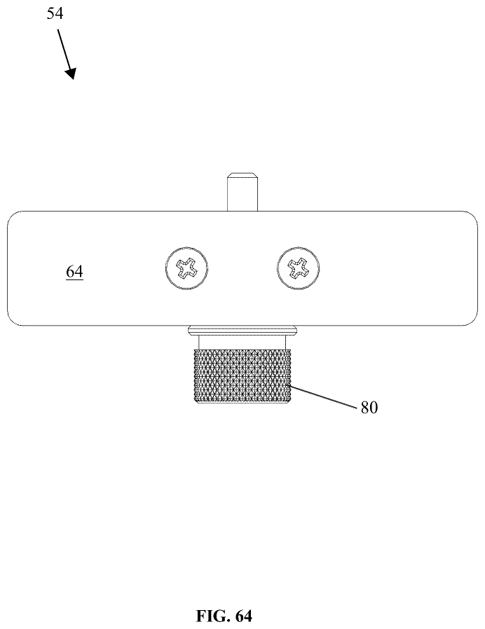

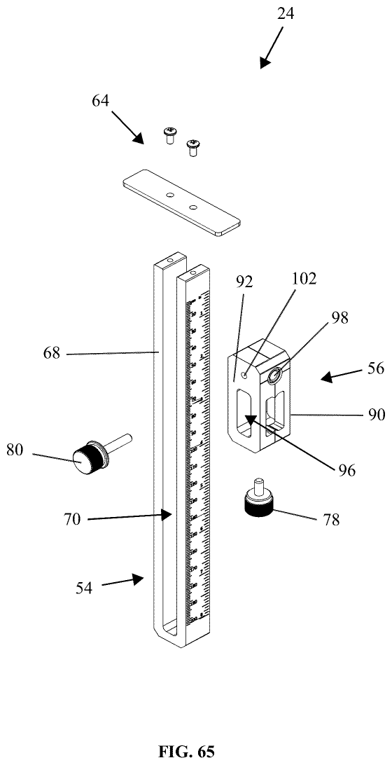

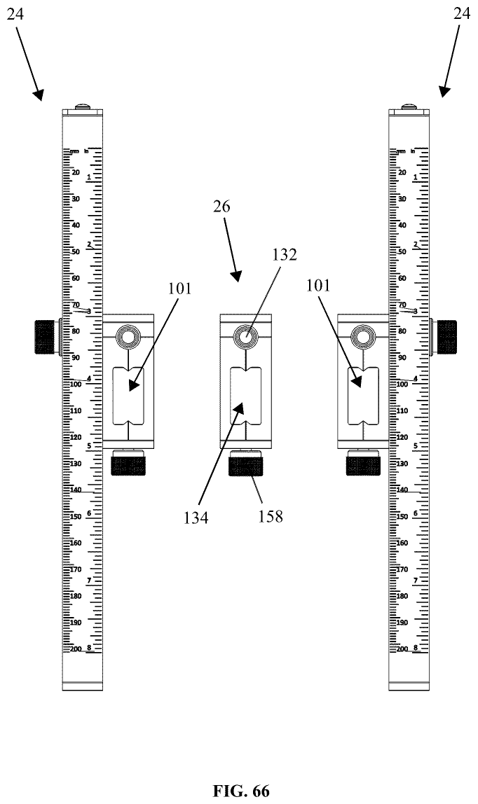

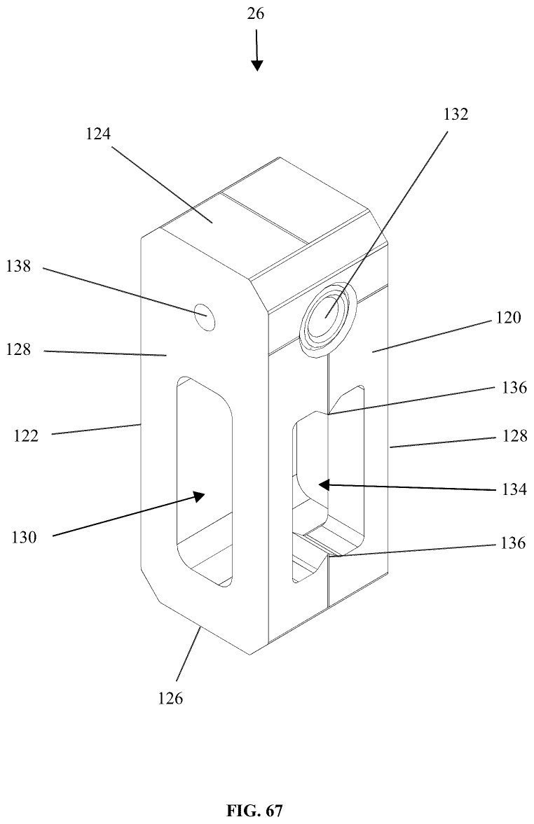

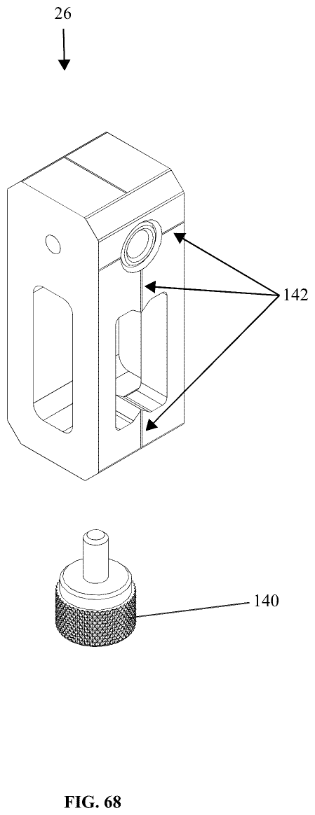

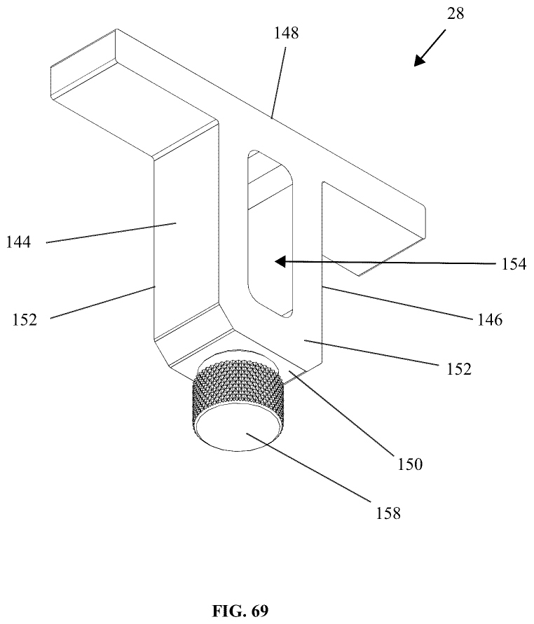

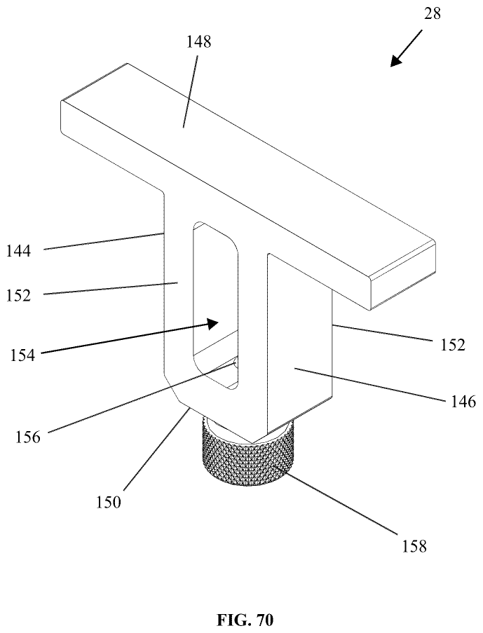

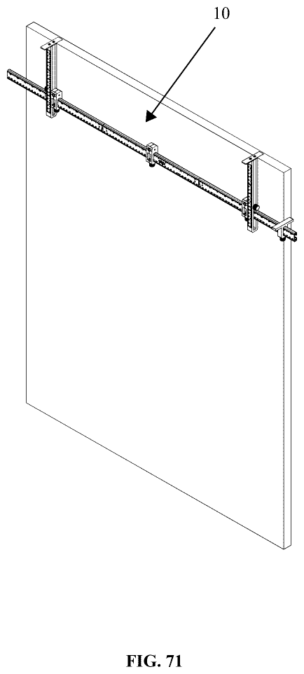

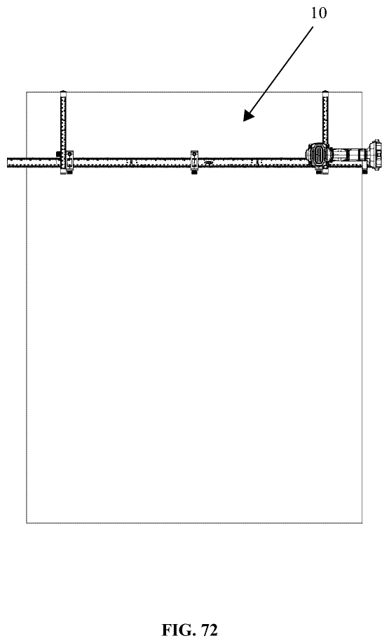

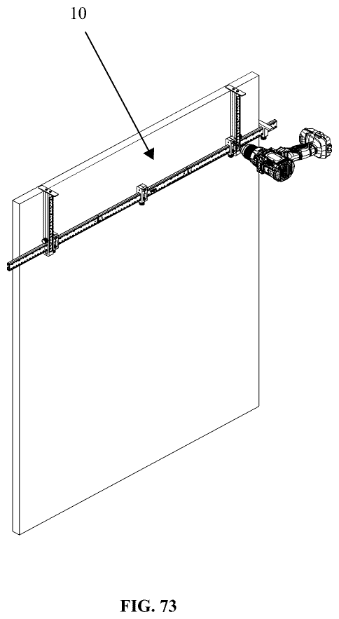

With reference to FIGS. 48-73, an alternative arrangement of extended length hardware jig system 10 is presented. The arrangement shown in FIGS. 48-73 is similar to the system 10 shown in FIGS. 1-47 and as such, the disclosure related to the embodiment shown in FIGS. 1-47 applies to the embodiment shown in FIGS. 48-73 unless stated specifically herein. The primary differences presented in the arrangements shown in FIGS. 48-73, relate to drill guide block 56 of outer block assembly 24 and center block 26.

### Outer Block Assembly 24:

### Drill Guide Block 26:

In the arrangement shown, as one example, outer block assembly 24 includes drill guide block 56. Drill guide block 56 is formed of any suitable size, shape, and design and is configured to operably connect to extension member 54, accurately indicate locations of a hole to be drilled, and allow a drill or awl to pass through drill guide block 56 in order to drill a hole in a workpiece. In the arrangement shown, as one example, drill guide block 56 has a front side 82, a back side 84, a top side 86, a bottom side 88, a first end 90, a second end 92, an opening 96, a drill aperture 98, a window 101, screw holes 102, a feature 103, and indication lines 105.

In the arrangement shown, as one example, drill guide block 56 is formed of a single, unitary member that is formed in a manufacturing process such as machining, casting, forming, additive manufacturing, or the like to form a unitary and monolithic member. Alternatively, drill guide block 56 may be formed of multiple pieces that are connected or assembled to one another through bolting, screwing, welding, friction fitting, or the like. In the arrangement shown, as one example, drill guide block 56 is formed primarily of a metallic material such as aluminum, steel, chromium, or any other metallic material, alloy, and/or composite thereof. Alternatively, drill guide block 56 may be formed of a non-metallic material such as a plastic material, a fiberglass material, or any other non-metallic material and/or composite thereof.

In the arrangement shown, as one example, drill guide block 56 is a generally rectangular member, extending a length between first end 90 and second end 92, a depth between front side 82 and back side 84, and a height between top side 86 and bottom side 88. In the arrangement shown, as one example, drill guide block 56 also includes an opening 96. Opening 96 is formed of any suitable size, shape, and design and is configured to allow rail 22 to be extended through drill guide block 56. In the arrangement shown, as one example, opening 96 extends through drill guide block 56 from the first end 90 to the second end 92.

In the arrangement shown, as one example, drill guide block 56 includes a drill aperture 98. Drill aperture 98 is formed of any suitable size, shape, and design and is configured to allow a drill bit, awl, or other tool to extend through drill guide block 56 in order to drill a hole in a workpiece. In the arrangement shown, as one example, drill aperture 98 extends through drill guide block 56 from the front side 82 to the back side 84 of drill guide block 56. In the arrangement shown, as one example, when the drill guide block 56 is properly positioned, the center of the drill aperture 98 will be accurately and properly placed in order to drill a hole in the workpiece.

In the arrangement shown, as one example, drill guide block 56 includes window 101. Window 101 is formed of any suitable size, shape, and design and is configured to allow the user of system 10 to see the indicia 40 on rail 22 when drill guide block 56 is positioned on rail 22, thereby allowing the user to properly position drill aperture 98 in drill guide block 56 in order to accurately drill holes in a workpiece. In the arrangement shown, as one example, window 101 is cut out of the front side 82 of drill guide block 56. In the arrangement shown, as one example, window 101 also includes feature 103. Feature 103 is configured to align with the center of the drill aperture 98 and is configured to easily allow the user to determine where the center of a hole will be located when drilled. In the arrangement shown, as one example, when drill guide block 56 is positioned on rail 22, window 101 allows the user to view indicia 40 and the user can align the feature 103 with the desired measurement, thereby allowing the user to properly and accurately place the drill guide block 56 to perform a drilling operation on the workpiece.

In the arrangement shown, as one example, drill guide block 56 includes indication lines 105. Indication lines 105 are formed of any suitable size, shape, and design and are configured to allow the user of system 10 to accurately align the center of the drill aperture 98 with the indicia 40 on rail 22 when drill guide block 56 is positioned on rail 22 and accurately align the center of the drill aperture 98 with the indicia 72 on extension member 54 when drill guide block 56 is positioned on extension member 54, thereby allowing the user to properly position drill aperture 98 in drill guide block 56 in order to accurately drill holes in a workpiece. In the arrangement shown, as one example, indication lines 105 extend horizontally across the front side 82 of drill guide block 56 intersecting the center of drill aperture 98 from the first end 90 to the second end 92 of drill guide block 56. In addition, in the arrangement shown, as one example, indication lines 105 extend vertically across the front side 82 of drill guide block 56 intersecting the center of drill aperture 98 from the top side 86 to the bottom side 88 of drill guide block 56.

In the arrangement shown, as one example, drill guide block 56 also includes screw holes 102. Screw holes 102 are formed of any suitable size, shape, and design and are configured to allow first thumb screw 78 and second thumb screw 80 to pass into drill guide block 56 in order to operably join drill guide block 56 to other components of system 10. In the arrangement shown, as one example, drill guide block 56 includes three screw holes 102. In the arrangement shown, as one example, a first screw hole 102 is positioned on the bottom side 88 of drill guide block 56 and is configured to allow first thumb screw 78 to extend through the screw hole 102 in order to engage rail 22 when rail 22 extends through drill guide block 56. When first thumb screw 78 is passed through the screw hole 102 on the bottom side 88 of drill guide block 56, the drill guide block 56 is operably and securely connected to rail 22.

In the arrangement shown, as one example, a second screw hole 102 is positioned on the second end 92 of drill guide block 56. In the arrangement shown, as one example, the second screw hole 102 is configured to receive second thumb screw 80 therein in order to operably connect and secure drill guide block 56 to one of the opposing ends 68 of extension member 54.

In the arrangement shown, as one example, a third screw hole 102 is positioned on the first end 90 of drill guide block 56. In the arrangement shown, as one example, the third screw hole 102 is configured to receive second thumb screw 80 if a user desires to operably connect and secure drill guide block 56 to the other opposing end 68 of extension member 54. With front member 60 of extension member 54 having indicia 72 displaying multiple units of measurement, one along each opposing end 68 of front member 60, a user can obtain accurate positioning of drill guide block 56 by securing drill guide block 56 to one of the opposing ends 68 of extension member 54 which displays the desired unit of measurement from indicia 72.

In the arrangement shown, as one example, extension member 54 and drill guide block 56 are operably connected to each other by second thumb screw 80 passing through open center 70 of extension member 54 and into the second or third screw hole 102 of drill guide block 56. In the arrangement shown, as one example, first end 90 or second end 92 of drill guide block 56 is placed alongside one of opposing ends 68 of extension member 54 at a predetermined position. In the arrangement shown, as one example, second thumb screw 80 is inserted through open center 70 of extension member 54 and into screw hole 102. Drill guide block 56 is secured to extension member 54 by tightening of second thumb screw 80 at any position along the length of extension member 54. A head of the second thumb screw 80 engages one of the opposing ends 68 of the extension member 54 to secure the drill guide block 56 to the other of the opposing ends 68 of the extension member. Said another way, the head of second thumb screw 80 is larger in diameter than the width of open center 70 between front member 60 and back member 62 of extension member 54, allowing second thumb screw 80 to secure drill guide block 56 to extension member 54.

Either before or after extension member 54 and drill guide block 56 are operably connected, rail 22 may be extended through the opening 96 of drill guide block 56 and the open center 70 of extension member 54. When rail 22 is extended through outer block assemblies 24 in this manner, the first thumb screw 78 may be extended through the appropriate screw hole 102 in drill guide block 56 and tightened. First thumb screw 78 will cause drill guide block 56 and rail 22 to press against each other, thereby tightly securing outer block assemblies 24 in place along rail 22.

While outer block assemblies 24 and its components have been described according the arrangement shown, as one example, it will be understood by those skilled in the art that any other configuration of outer block assemblies 24 and its components may be used in order to move along rail 22, engage an edge of a workpiece, and allow a user to accurately position and drill holes in the workpiece.

### Center Block 26:

In the arrangement shown, as one example, system 10 includes a center block 26. Center block 26 is formed of any suitable size, shape, and design and is configured to move along rail 22 and allows a user to accurately position and drill holes in a workpiece. In the arrangement shown, as one example, there is one center block 26, however there may be any number of center blocks 26 included in system 10.

In the arrangement shown, as one example, center block 26 is similar in design to drill guide block 56 of outer block assembly 24. As such, center block 26 and drill guide block 56 of outer block assembly 24 are interchangeable components of system 10. Said another way, center block 26 may be converted into an outer block assembly 24 by adding a second thumb screw 80 and extension member 54 to an existing center block 26. The similarities between center block 26 and drill guide block 56 provide a user with added flexibility with how they would like to arrange system 10. In an alternate arrangement, as one example, a user may convert one or more center blocks 26 to outer block assemblies 24 to have additional points of contact with an edge of a workpiece.

In the arrangement shown, as one example, center block 26 includes three screw holes 138. Screw holes 138 are formed of any suitable size, shape, and design and are configured to allow thumb screw 140 of center block 26 to pass into center block 26 in order to operably join center block 26 to other components of system 10. In the arrangement shown, as one example a first screw hole 138 is positioned on the bottom side 126 of center block 26 and is configured to allow thumb screw 140 to extend through the screw hole 138 in order to engage rail 22 when rail 22 extends through center block 26. When thumb screw 140 is passed through the screw hole 138 on the bottom side 126 of center block 26, the center block 26 is operably and securely connected to rail 22.

In an alternate arrangement, as one example, second thumb screw 80 of outer block assembly 24 may also pass into two screw holes 138 located on opposing ends 128 of center block 26 in order to operably join center block 26 an extension member 54 of outer block assembly 24. Said another way, the two screw holes 138 located on opposing ends 128 of center block 26 make center block 26 identical in design to drill guide block 56 and therefore interchangeable components of system 10.

In the arrangement shown, as one example, center block 26 includes indication lines 142. Indication lines 142 are formed of any suitable size, shape, and design and are configured to allow the user of system 10 to accurately align the center of the drill aperture 132 with the indicia 40 on rail 22 when center block 26 is positioned on rail 22. In an alternate arrangement, as one example, indication lines 142 may be used to accurately align the center of the drill aperture 132 with the indicia 72 on extension member 54 when center block 26 is operably connected to extension member 54, thereby allowing the user to properly position drill aperture 132 in drill center block 26 in order to accurately drill holes in a workpiece. In the arrangement shown, as one example, indication lines 142 extend horizontally across the front side 120 of center block 26 intersecting the center of drill aperture 132 from opposing ends 128 of center block 26. In addition, in the arrangement shown, as one example, indication lines 142 extend vertically across the front side 120 of center block 26 intersecting the center of drill aperture 132 from the top side 124 to the bottom side 126.

While center block 26 and its components have been described according the arrangement shown, as one example, it will be understood by those skilled in the art that any other configuration of center block 26 and its components may be used in order to move along rail 22 and allow a user to accurately position and drill holes in a workpiece.

### In Operation:

Either before or after rail 22 is connected, the user must put together the outer block assemblies 24. The user may take the extension member 54 and align the opening 96 of the drill guide block 56 with the open center 70 of the extension member 54. At this point, the user can move the drill guide block 56 along the height of extension member 54 in order to position the drill guide block 56 at the proper position for the holes needed on the workpiece. Once the drill guide block 56 is properly positioned, as indicated by the indicia 72 on the front member 60 of the extension member 54, the user can then insert second thumb screw 80 through the open center 70 of extension member 54 into screw hole 102 in the first end 90 or second end 92 of drill guide block 56, thereby bringing the drill guide block 56 into secure engagement with extension member 54 so that drill guide block 56 can no longer slide along the height of extension member 54 between the top member 64 and bottom member 66. A head of the second thumb screw 80 engages one of the opposing ends 68 of the extension member 54 to secure the drill guide block 56 to the other of the opposing ends 68 of the extension member. Once completed, the outer block assemblies 24 have been completed.

Once outer block assemblies 24 and rail 22 are assembled, an outer block assembly 24 can be placed onto rail 22. In order to do so, the rail 22 is aligned with and extended through the opening 96 of drill guide block 56 and the open center 70 of extension member 54. Once on rail 22, the user can use the indicia 40 on the front side 36 of rail 22 to properly align the position of the outer block assembly 24. The user can align the feature 103 and/or indication lines 105 of drill guide block 56 with the desired measurement, as indicated by indicia 40 and, once properly aligned, the user can thread the first thumb screw 78 through the screw hole 102 in the bottom side 88 of drill guide block 56. Once threaded through the screw hole 102 in the bottom side 88 of drill guide block 56, the first thumb screw 78 engages rail 22 and holds the outer block assembly 24 in place so that it can no longer move along the length of rail 22.

Once the first outer block assembly 24 is properly positioned on rail 22, one or more center blocks 26 may be positioned on rail 22. This is done by extending the rail 22 through the opening 130 of center block 26 and positioning center block 26 by aligning the feature 136 of center block 26 with the desired measurement as indicated by the indicia 40 on the front side 36 of rail 22. Once properly positioned along rail 22, thumb screw 140 can be threaded into screw hole 138 and once thumb screw 140 is threaded, thumb screw 140 engages rail 22 and holds the center block 26 in place so that it can no longer move along the length of rail 22.

From the above discussion it will be appreciated that the system 10 presented herein improves upon the state of the art. Specifically, in one or more arrangements, a system 10 is presented which: improves upon the state of the art; is safe to operate; is able expand in order to properly place holes in workpieces such as doors or drawers; is relatively easy to build; is relatively friendly to build; can be built relatively quickly and efficiently; is easy to operate; is relatively cost friendly to manufacture; is relatively easy to transport; is aesthetically appealing; is robust; is relatively inexpensive; is not easily susceptible to wear and tear; has a long useful life; is efficient to use and operate; is accurate over long distances.

What is claimed:

1. A jig system for locating holes on a workpiece, the system comprising:
a rail;
the rail extending a length between a first end and a second end;
a first extension member extending a length between a first end and a second end;
a first outer block assembly;
the first outer block assembly having a first drill aperture;
the first outer block assembly operably connected to the rail and configured to move relative to the rail in a first direction;
the first outer block assembly operatively connected to the first extension member;
the first extension member configured to move relative to the rail in a second direction;
wherein the first extension member is configured to engage the workpiece at a first point of contact;
a second extension member extending a length between a first end and a second end;
a second outer block assembly;
the second outer block assembly having a second drill aperture;
the second outer block assembly operably connected to the rail and configured to move relative to the rail in the first direction;
the second outer block assembly operatively connected to the second extension member;
the second extension member configured to move relative to the rail in the second direction;
wherein the second extension member is configured to engage the workpiece at a second point of contact;
wherein a drill is configured to extend through the first drill aperture of the first outer block assembly to drill a first hole in the workpiece; and
wherein the drill is configured to extend through the second drill aperture of the second outer block assembly to drill a second hole in the workpiece.

2. The system of claim 1, wherein the first drill aperture of the first outer block assembly and the second drill aperture of the second outer block assembly have independently accurate vertical measurements.

3. The system of claim 1, wherein the first drill aperture of the first outer block assembly and the second drill aperture of the second outer block assembly have independently accurate horizontal measurements.

4. The system of claim 1, wherein the holes drilled in the workpiece are accurately positioned.

5. The system of claim 1, wherein the first point of contact and the second point of contact are both along an edge of the workpiece.

6. The system of claim 1, wherein the first drill aperture of the first outer block assembly is positioned substantially downward from the first point of contact; and wherein the second drill aperture of the second outer block assembly is positioned substantially downward from the second point of contact.

7. The system of claim 1, wherein additional pieces can be added to the rail to extend the length of the rail.

8. The system of claim 1, further comprising a first locking member operably connected to the first outer block assembly and a second locking member operably connected to the second outer block assembly; wherein the first locking member is configured to secure the first outer block assembly at any position along the length of the rail; and wherein the second locking member is configured to secure the second outer block assembly at any position along the length of the rail.

9. The system of claim 1, further comprising a first locking member operably connected to the first outer block assembly and a second locking member operably connected to the second outer block assembly; wherein the first locking member is configured to secure the first outer block assembly at any position along the length of the first extension member; and wherein the second locking member is configured to secure the second outer block assembly at any position along the length of the second extension member.

10. The system of claim 1, wherein the rail includes indicia indicating measurement along the length of the rail.

11. The system of claim 1, wherein the rail includes indicia indicating measurement along the length of the rail;
wherein the indicia is referenced in order to move the first outer block assembly to a first predetermined position along the rail; and
wherein the indicia is referenced in order to move the second outer block assembly to a second predetermined position along the rail.

12. The system of claim 1, wherein the rail includes indicia indicating measurement along the length of the rail; wherein the first outer block assembly further comprises a window and indicia; wherein the window permits a user to see the indicia of the rail for alignment of the first drill aperture; wherein the indicia of the first outer block assembly permits a user to align a center point of the first drill aperture with the indicia of the rail.

13. The system of claim 1, wherein the first extension member includes indicia indicating measurement along the length of the first extension member; and wherein the second extension member includes indicia indicating measurement along the length of the second extension member.

14. The system of claim 1, wherein the first extension member includes indicia indicating measurement along the length of the first extension member; wherein the first outer block assembly includes indicia; wherein the indicia of the first outer block assembly permits a user to align a center point of the first drill aperture with the indicia of the first extension member.

15. The system of claim 1, wherein the first extension member includes indicia indicating measurement along the first extension member;
wherein the second extension member includes indicia indicating measurement along the second extension member;
wherein the indicia on the first extension member is referenced in order to move the first outer block assembly to a first predetermined position along the first extension member; and
wherein the indicia on the second extension member is referenced in order to move the second outer block assembly to a second predetermined position along the second extension member.

16. The system of claim 1, further comprising:
a third outer block assembly;
wherein the third outer block assembly is operatively connected to the rail and configured to move a third drill aperture relative to the rail in the first direction;
wherein the drill is configured to extend through the third drill aperture of the third outer block assembly to drill a third hole in the workpiece.

17. The system of claim 1, further comprising:
an end stop;
wherein the end stop is operatively connected to the rail and configured to move relative to the rail in the first direction; and
wherein the end stop is configured to engage the workpiece at a third point of contact.

18. The system of claim 1, further comprising:
an end stop;
wherein the end stop is operatively connected to the rail and configured to move relative to the rail in the first direction;
wherein the end stop is configured to engage the workpiece at a third point of contact.

19. A jig system for locating holes on a workpiece, the system comprising:
a rail;
the rail extending a length between a first end and a second end;
the rail having indicia indicating measurement along the length of the rail;
a first extension member extending a length between a first end and a second end;
the first extension member having indicia indicating measurement along the first extension member;
a first outer block assembly;
the first outer block assembly having a first drill aperture;
the first outer block assembly operably connected to the rail and configured to move relative to the rail in a first direction;
the first outer block assembly operatively connected to the first extension member;
the first extension member configured to move relative to the rail in a second direction;
wherein the first extension member is configured to engage the workpiece at a first point of contact;
a second extension member extending a length between a first end and a second end;
the second extension member having indicia indicating measurement along the second extension member;
a second outer block assembly;
the second outer block assembly having a second drill aperture;
the second outer block assembly operably connected to the rail and configured to move relative to the rail in the first direction;
the second outer block assembly operatively connected to the second extension member;
the second extension member configured to move relative to the rail in the second direction;
wherein the second extension member is configured to engage the workpiece at a second point of contact;
wherein the first drill aperture of the first outer block assembly is positioned substantially downward from the first point of contact;
wherein the second drill aperture of the second outer block assembly is positioned substantially downward from the second point of contact; and
wherein a drill is configured to extend through the first drill aperture of the first outer block assembly to drill a first hole in the workpiece;
wherein the drill is configured to extend through the second drill aperture of the second outer block assembly to drill a second hole in the workpiece.

20. The system of claim 19, wherein the first drill aperture of the first outer block assembly and the second drill aperture of the second outer block assembly have independently accurate vertical measurements.

21. The system of claim 19, wherein the first drill aperture of the first outer block assembly and the second drill aperture of the second outer block assembly have independently accurate horizontal measurements.

22. The system of claim 19, further comprising a first locking member operably connected to the first outer block assembly and a second locking member operably connected to the second outer block assembly; wherein the first locking member is configured to secure the first outer block assembly at any position along the length of the rail; and wherein the second locking member is configured to secure the second outer block assembly at any position along the length of the rail.

23. The system of claim 19, further comprising a first locking member operably connected to the first outer block assembly and a second locking member operably connected to the second outer block assembly; wherein the first locking member is configured to secure the first outer block assembly at any position along the length of the first extension member; and wherein the second locking member is configured to secure the second outer block assembly at any position along the length of the second extension member.

24. The system of claim 19 wherein the indicia on the first extension member is referenced in order to move the first outer block assembly to a first predetermined position along the first extension member; and
wherein the indicia on the second extension member is referenced in order to move the second outer block assembly to a second predetermined position along the second extension member.

25. The system of claim 19 wherein the indicia on the rail is referenced in order to move the first outer block assembly to a first predetermined position along the rail; and
wherein the indicia on the rail is referenced in order to move the second outer block assembly to a second predetermined position along the rail.

26. The system of claim 19, wherein the first outer block assembly further comprises a window and indicia; wherein the window permits a user to see the indicia of the rail for alignment of the first drill aperture; wherein the indicia of the first outer block assembly permits a user to align a center point of the first drill aperture with the indicia of the rail.

27. The system of claim 19, wherein the first outer block assembly includes indicia; wherein the indicia of the first outer block assembly permits a user to align a center point of the first drill aperture with the indicia of the first extension member.

28. The system of claim 19, further comprising:
a third outer block assembly;
the third outer block assembly having a third drill aperture;
wherein the third outer block assembly is operatively connected to the rail and configured to move relative to the rail in the first direction;
wherein the drill is configured to extend through the third drill aperture of the third outer block assembly to drill a third hole in the workpiece.

29. The system of claim 19, further comprising:
an end stop;
wherein the end stop is operatively connected to the rail and configured to move relative to the rail in the first direction; and
wherein the end stop is configured to engage the workpiece at a third point of contact.

30. A jig system for locating holes on a workpiece, the system comprising:
a rail;
the rail extending a length between a first end and a second end;
a pair of outer block assemblies;
the pair of outer block assemblies operably connected to and configured to be movable along the length of the rail;
the pair of outer block assemblies having a pair of drill apertures;
the pair of outer block assemblies operably connected to a pair of extension members;
the pair of extension members each extending a length between a first end and a second end;
the pair of outer block assemblies operably connected to the pair of extension members;
the pair of extension members configured to be movable vertically along the pair of outer block assemblies;
wherein the pair of outer block assemblies are configured to independently engage an edge of the workpiece;
wherein the pair of outer block assemblies are configured to be positioned at predetermined locations along the length of the rail;
wherein the pair of outer block assemblies are configured to be positioned at predetermined locations along the length of the pair of extension members;
wherein when the pair of outer block assemblies are positioned at the predetermined locations on the rail and the predetermined locations on the pair of extension members, a drill can be extended through the pair of drill apertures to form holes in the workpiece.

31. The system of claim 30, wherein additional pieces can be added to the rail to extend the length of the rail.

32. The system of claim 30, wherein the rail includes indicia indicating measurement along the length of the rail.

33. The system of claim 30, wherein the pair of extension members include indicia indicating measurement along the length of the extension members.

34. The system of claim 30, further comprising:
a third outer block assembly;
the third outer block assembly having a third drill aperture;
wherein the third outer block assembly is operatively connected to the rail and configured to move relative to the rail in the first direction;
wherein the drill is configured to extend through the third drill aperture of the third outer block assembly to drill a third hole in the workpiece.

35. The system of claim 30, further comprising:
an end stop;
wherein the end stop is operatively connected to the rail and configured to move relative to the rail in the first direction; and
wherein the end stop is configured to engage the workpiece at a third point of contact.
